(19) United States
(12) Patent Application Publication
(10) Pub. No.: US 2025/0106801 A1
(43) Pub. Date: Mar. 27, 2025

(54) REGISTRATION AND SELECTION OF USER EQUIPMENT FOR WIRELESS NETWORK SENSING SERVICES

(71) Applicant: Nokia Technologies Oy, Espoo (FI)

(72) Inventors: Shubhranshu SINGH, Munich (DE); Hideaki TAKAHASHI, Tokyo (JP); Apostolos KOUSARIDAS, Munich (DE); Laurent THIÉBAUT, Massy (FR); Pallab GUPTA, Bangalore (IN)

(21) Appl. No.: 18/823,091

(22) Filed: Sep. 3, 2024

(30) Foreign Application Priority Data
Sep. 22, 2023 (GB) 2314556.8

(51) Int. Cl. H04W 60/00; H04W 68/00; H04W 76/27

(52) U.S. Cl. CPC H04W 60/00; H04W 68/005; H04W 76/27

(57) ABSTRACT

A method in a user equipment (UE) is presented that includes transmitting, by a UE, to one or more components of a core network, a message including information indicating one or more sensing capabilities of the UE; and receiving, by the UE, one of the following: an indication that the UE is registered in connection with sensing services provided by one or more components of the core network, or an indication that the UE is not registered in connection with the sensing services provided by one or more components of the core network.

### FIELD

Various example embodiments relate generally to wireless networks and, more particularly, to sensing services provided by wireless networks.

### BACKGROUND

Wireless networking provides significant advantages for user mobility. A user's ability to remain connected while on the move provides advantages not only for the user, but also provides greater efficiency and productivity for society as a whole. As user expectations for connection reliability, processing power, data speed, and device battery life, become more demanding, technology for wireless networking must also keep pace with such expectations. Additionally, widespread geographic coverage provided by wireless networking infrastructure and user equipment may provide new opportunities for new technical innovations to serve widespread geographies. Accordingly, there is continuing interest in improving wireless networking technology and services.

### SUMMARY

In accordance with aspects of the disclosure, a method in a user equipment (UE) is presented. The method includes transmitting, by a UE, to one or more components of a core network, a message including information indicating one or more sensing capabilities of the UE; and receiving, by the UE, one of the following: an indication that the UE is registered in connection with sensing services provided by the one or more components of the core network, or an indication that the UE is not registered in connection with the sensing services provided by the one or more components of the core network.

In an aspect of the method, the message may be a registration request configured to register the UE with an access and mobility management function (AMF) of the core network. The registration request comprises the information indicating the one or more sensing capabilities of the UE.

In an aspect of the method, the message may further include information indicating at least one of the following: the UE capable of operation in a monostatic mode for the sensing service, the UE capable of operating in a bistatic mode for the sensing services, the UE capable of a transmission role for the sensing services, the UE capable of a reception role for the sensing services, the UE capable of sidelink sensing for the sensing services, or at least one type of sensing signal that the UE is capable of at least one of: receiving or transmitting.

In an aspect of the method, the indication, that the UE may be registered in connection with the sensing services provided by the one or more components of the core network, is an indication that the UE is subscribed to the sensing services.

In an aspect of the method, the indication, that the UE may not be registered in connection with the sensing services provided by the one or more components of the core network, is an indication that the UE is not subscribed to the sensing services.

In an aspect of the method, the method may further include receiving, by the UE while in connection management-idle (CM-Idle) state, based on the indication that the UE is registered in connection with the sensing services, a paging message in connection with the sensing service,

The paging message may include a request for a sensing method.

In an aspect of the method, the method may further include determining, by the UE, whether the UE is capable of the sensing method; and based on the determining, one of the following: accepting the request for the sensing method, or declining the request for the sensing method.

In an aspect of the method, the method may further include initiating connection establishment for changing, by the UE, based on the accepting the request for the sensing method, from the CM-Idle state to a connection management-connected (CM-Connected) state.

In accordance with aspects of the disclosure, a user equipment includes at least one processor; and at least one memory storing instructions which, when executed by the at least one processor, cause the user equipment at least to perform a method as in any of the preceding claims.

In accordance with aspects of the disclosure, a method includes receiving, by one or more components of a core network, a message including information indicating one or more sensing capabilities of a user equipment (UE); transmitting, by the one or more components of the core network, one of the following: an indication that the UE is registered in connection with sensing services provided by the one or more components of the core network, or an indication that the UE is not registered in connection with the sensing services provided by the one or more components of the core network.

In an aspect of the method, the message may be a registration request configured to register the UE with an access and mobility management function (AMF) of the core network. The registration request comprises the information indicating the one or more sensing capabilities of the UE.

In an aspect of the method, the method may further include receiving, by the AMF, from a unified data management function (UDM) of the core network, subscription information of the UE with regard to the sensing services; and determining, by the AMF, based on the subscription information of the UE with regard to the sensing services, whether to accept or decline the registration request.

In an aspect of the method, the method may further include transmitting, by the AMF to a management function of the core network supporting the sensing service, based on acceptance of the registration request, a second message including the information indicating the one or more sensing capabilities of the UE, the second message configured to update a database storing sensing capabilities of UEs.

In an aspect of the method, the message may further include information indicating at least one of the following: the UE capable of operation in a monostatic mode for the sensing service, the UE capable of operating in a bistatic mode for the sensing services, the UE capable of a transmission role for the sensing services, the UE capable of a reception role for the sensing services, the UE capable of sidelink sensing for the sensing services, or at least one type of sensing signal that the UE is capable of at least one of: receiving or transmitting.

In an aspect of the method, the transmitting may include transmitting the indication that the UE is registered in connection with the sensing services provided by the one or more components of the core network. The UE is in connection management-connected (CM-Connected) state.

In an aspect of the method, the method may further include receiving a request for the sensing services, the receiving by at least one network function of the following: a management function, of the core network, that supports the sensing services (SeMF), or a network exposure function of the core network. The request for the sensing services indicates a sensing area of interest and transmitting, by the network function, to an access and mobility management function (AMF) of the core network, a request for the AMF to discover at least CM-Connected UEs for the request for the sensing services.

In an aspect of the method, the method may further include obtaining, by the network function, a plurality of defined target areas for the sensing service; and mapping, by the network function, the sensing area of interest to at least one target area of the plurality of define target areas. The request for the AMF to discover at least CM-Connected UEs for the request for the sensing services comprises at least one identifier corresponding to the at least one target area mapped to the sensing area of interest.

In an aspect of the method, the method may further include determining, by the AMF, at least one network node serving the at least one target area; and transmitting, by the AMF, to the at least one network node, a request for the at least one network node to discover at least CM-Connected UEs for fulfilling the request for the sensing services. The UE in the CM-Connected state is served by one of the at least one network node.

In an aspect of the method, the request for the at least one network node to discover at least CM-Connected UEs for the request for the sensing services may include at least one of the following: a requested sensing method, UE selection criteria, or number of UEs needed to fulfill the request for the sensing services.

In an aspect of the method, the method may further include receiving, by the AMF, from the at least one network node, discovered information including: at least one identifier corresponding to at least one CM-Connected UE discovered for the request for the sensing services, and for each of the at least one CM-Connected UE, a respective confidence level indicating a level of capability of the respective CM-Connected UE to fulfill the request for the sensing services; and transmitting, by the AMF to the SeMF, the discovered information.

In an aspect of the method, the method may further include selecting, by the SeMF, based on at least the discovered information, at least one of the at least one CM-Connected UE to fulfill the request for the sensing services.

In an aspect of the method, the transmitting may include transmitting the indication that the UE is registered in connection with the sensing services provided by the one or more components of the core network. The UE is in connection management-idle (CM-Idle) state.

In an aspect of the method, the method may further include receiving a request for the sensing services, the receiving by at least one network function of the following: a management function, of the core network, that supports the sensing services (SeMF), or a network exposure function of the core network. The request for the sensing services indicates a sensing area of interest; and transmitting, by the network function, to an access and mobility management function (AMF) of the core network, a request for the AMF to discover at least CM-Idle UEs for the request for the sensing services.

In an aspect of the method, the method may further include obtaining, by the network function, a plurality of defined target areas for the sensing service; mapping, by the network function, the sensing area of interest to at least one target area of the plurality of define target areas. The request for the AMF to discover at least CM-Idle UEs for the request for the sensing services comprises at least one identifier corresponding to the at least one target area mapped to the sensing area of interest.

In an aspect of the method, the method may further include obtaining, by the AMF, for each CM-Idle UE of a plurality of CM-Idle UEs registered with the AMF: at least one respective target area, of the plurality of defined target areas, that is associated with the respective CM-Idle UE; determining, by the AMF, at least one CM-Idle UE, of the plurality of CM-Idle UEs registered with the AMF, which has at least one associated target area that overlaps with the at least one target area mapped to the sensing area of interest; determining, by the AMF, at least one network node serving the at least one target area mapped to the sensing area of interest; and transmitting, by the AMF, to the at least one network node, a request to for the at least one network node to perform paging for the at least one CM-Idle UE for fulfilling the request for the sensing services. The UE in the CM-Idle state is served by one of the at least one network node.

In an aspect of the method, the request for the at least one network node to perform paging for the at least one CM-Idle UE for fulling the request for the sensing services may include at least one of the following: a requested sensing method, or a setting for the at least one network node to perform paging for any UE having sensing capability.

In an aspect of the method, the method may further include establishing, by the AMF, signaling connection with at least one of the at least one CM-Idle UE, the at least one of the at least one CM-Idle UE changing to connection management-connected (CM-Connected) state and becoming at least one CM-Connected UE.

In an aspect of the method, the method may further include, for each of the at least one CM-Connected UE: receiving, by the AMF, from at least one of the at least one network node, a respective confidence level indicating a level of capability of the respective CM-Connected UE to fulfill the request for the sensing services; and transmitting, by the AMF to the SeMF, the respective confidence level for the respective CM-Connected UE.

In an aspect of the method, the method may further include selecting, by the SeMF, based on the at least one confidence level corresponding to the at least one CM-Connected UE, at least one of the at least one CM-Connected UE to fulfill the request for the sensing services.

In accordance with aspects of the disclosure, an apparatus includes at least one processor; and at least one memory storing instructions which, when executed by the at least one processor, cause the apparatus at least to perform a method as in any of the preceding claims.

In accordance with aspects of the disclosure, a method includes receiving, by one or more components of a radio access network (RAN), a message including information indicating one or more sensing capabilities of a user equipment (UE); transmitting, by the one or more components of the RAN, one of the following: an indication that the UE is registered in connection with sensing services provided by the one or more components of a core network, or an indication that the UE is not registered in connection with the sensing services provided by the one or more components of the core network.

In an aspect of the method, the message may be a registration request configured to register the UE with an access and mobility management function (AMF) of the core network. The registration request comprises the information indicating the one or more sensing capabilities of the UE.

In an aspect of the method, the method may further include receiving, by at least one network node of the RAN, from an access and mobility management function (AMF) of the core network, at least one identifier for at least one target area which covers a sensing area of interest, the sensing area of interest specified in a request for the sensing services. The at least one network node services the at least one target area; and receiving, by the at least one network node of the RAN, from the AMF, a request to discover at least connection management-connected (CM-Connected) UEs in the at least one target area.

In an aspect of the method, the request to discover at least CM-Connected UEs in the at least one target area comprises at least one of the following: a requested sensing method, UE selection criteria, or number of UEs needed to fulfill the request for the sensing services.

In an aspect of the method, the method may further include obtaining, by the at least one network node of the RAN, discovered information including: at least one identifier corresponding to at least one CM-Connected UE discovered for the request for the sensing services, and for each of the at least one CM-Connected UE, a respective confidence level indicating a level of capability of the respective CM-Connected UE to fulfill the request for the sensing services; and transmitting, by the at least one network node of the RAN, to the AMF, the discovered information.

In an aspect of the method, the method may further include receiving, by at least one network node of the RAN, from an access and mobility management function (AMF) of the core network, at least one identifier for at least one target area which covers a sensing area of interest, the sensing area of interest specified in a request for the sensing services. The at least one network node services the at least one target area; and receiving, by the at least one network node of the RAN, from the AMF, a request to perform paging for at least one connection management-idle (CM-Idle) UE for fulfilling the request for the sensing service.

In an aspect of the method, the request to perform paging for the at least one CM-Idle UE for fulling the request for the sensing services may include at least one of the following: a requested sensing method, or a setting for the at least one network node to perform paging for any UE having sensing capability.

In an aspect of the method, the method may further include transmitting, by the at least one network node of the RAN, to the at least one CM-Idle UE, a paging message configured to cause at least one of the at least one CM-Idle UE to initiate connection establishment to change to a connection management-connected (CM-Connected) state, the at least one of the at least one CM-Idle UE becoming at least one CM-Connected UE.

In an aspect of the method, the method may further include, for each of the at least one CM-Connected UE: determining, by a network node of the RAN, a respective confidence level indicating a level of capability of the respective CM-Connected UE to fulfill the request for the sensing services; and transmitting, by the at least one network node of the RAN, to the AMF, the respective confidence level for the respective CM-Connected UE.

In accordance with aspects of the disclosure, an apparatus includes at least one processor; and at least one memory storing instructions which, when executed by the at least one processor, cause the apparatus at least to perform a method as in any of the preceding claims.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE), according to one illustrated aspect of the disclosure;

FIG. 2 is a diagram of example components of a network system, according to one illustrated aspect of the disclosure;

FIG. 3 diagram illustrating an example use case where the user equipment is assistance in UAV flight trajectory, according to one illustrated aspect of the disclosure;

FIG. 4 is a diagram illustrating another example use case where the user equipment is providing transparent sensing, spatial mapping, and localization, according to one illustrated aspect of the disclosure;

FIG. 5 is a diagram illustrating another example use case where the user equipment is detecting an intruder in smart home, according to one illustrated aspect of the disclosure;

FIG. 6 is a diagram illustrating example signals and operations of a network system, according to one illustrated aspect of the disclosure;

FIG. 7A and FIG. 7B are diagrams of example signals and operations of a network system, according to one illustrated aspect of the disclosure;

FIG. 8 is a diagram of example embodiment of signals and operations of components of a user equipment or of a network apparatus, according to one illustrated aspect of the present disclosure;

FIG. 9 is a diagram of example embodiment user equipment having different confidence level with respect to a sensing area of interest, according to one illustrated aspect of the present disclosure;

FIG. 10A and FIG. 10B are diagrams of example embodiment signals and operations of components of a user equipment or of a network apparatus, according to one illustrated aspect of the present disclosure; and

FIG. 11 is a diagram of example embodiment of components of a user equipment or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE™), LTE-Advanced™, enhanced LTE™ (eLTE™), 5G New Radio (5G NR), 5G Advance, 6G (and beyond) and 802.11ax (Wi-Fi™ 6), among other wireless networking systems. The term ‘eLTE™’ here denotes the LTE™ evolution that connects to a 5G core. LTE™ is also known as evolved UMTS terrestrial radio access (EUTRA) or as evolved UMTS terrestrial radio access network (EUTRAN).

Aspects of the present disclosure relate to a network service that uses the widespread geographic coverage of wireless networking infrastructure and user equipment (UE) to provide sensing services. The network service will be referred to herein as “sensing management function” or “SeMF” and, as described herein, may be implemented in a core network of a wireless network. As explained in more detail below herein, the network service is based on collaboration between wireless network infrastructure and UEs. In aspects, UEs with sensing capabilities may be called upon by the SeMF to perform sensing and to report sensed data to the SeMF. In aspects, the SeMF may call upon UEs to transmit signals for network nodes (e.g., gNB) to sense, and the network nodes may report sensed data to the SeMF. In aspects, the SeMF may call upon UEs to sense signals transmitted by network nodes and to report sensed data to the SeMF. The terms sensing management function and SeMF are merely examples of names for the network function. It is contemplated that the network function may be called any other name or may be implemented into any other network function.

UE sensing capabilities may include one or more of the following: indication of parameters/features/types of sensing data that can be collected by the UE and, if available, information about the granularity of collected sensing data; indication of available sensing resources; local processing capability of sensing measurements/data; UE obfuscation capability on sensing measurements/data; indication of supported sensing services; indication on sensing using uplink (UL) and/or downlink (DL) pilot or reference signals for channel parameter estimation; indication on sensing using data or user plane signals for channel parameter estimation; indication of the (maximum) number of sensing resources (e.g., DL and/or UL sensing reference signals, data or user plane signals) supported by the respective UE ID, per sensing frequency layer; indication of (number of) sensing frequency layers on a certain frequency band; indication of supported frequency band for sensing (e.g., central frequency, bandwidth, 3GPP™ NR FR1 (n1, n3, n77, etc.), 3GPP™ NR FR2 (n257, n258, etc.)), supported frequency range for sensing (e.g., 600 MHz to 6 GHZ, 24 GHz to 71 GHz), supported Radio Access Technology for sensing, max Tx power, supported bandwidth, sensing signal interval, etc.

In aspects, one or more network subscriptions may be implemented specifically with regard to enrolling a UE in the sensing services. The SeMF may operate as a sensing service provider to application functions in the core network and/or to applications in a UE, which would operate as sensing service consumers. These and other aspects are described in detail below.

The present disclosure may use the term “serving network device” to refer to a network node or network device (or a portion thereof) that serves a UE. As used herein, the terms “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

As used herein, the term “apparatus” refers to and includes a physical implementation that may include one housing and/or component or may include more than one housing and/or component. In case of more than one housing and/or component, the multiple housings and/or components of an apparatus may be co-located or may be geographically separated.

The present disclosure uses 5G NR as an example of a wireless network and may use smartphones and/or IoT devices as an example of UEs. It is intended and shall be understood that such examples are merely illustrative, and the present disclosure is applicable to other wireless networks and user equipment.

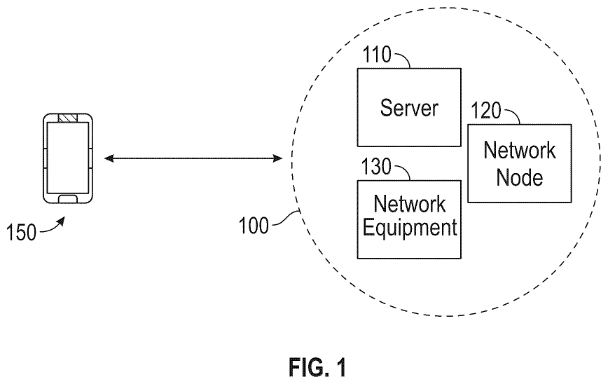

FIG. 1 is a diagram depicting an example of wireless networking between a network system 100 and a user equipment (UE) 150. The network system 100 may include one or more network nodes 120, one or more servers 110, and/or one or more network equipment 130 (e.g., physical infrastructure). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, aspects of a radio access network (RAN), or aspects of a core network, among others. The present disclosure describes embodiments related to 5G NR and embodiments that involve aspects defined by 3rd Generation Partnership Project (3GPP™). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides NR user plane and control plane protocol terminations towards the UE and that is connected via a NG interface to the 5G core (5GC), e.g., according to 3GPP™ TS 38.300 V16.6.0 (2021 June) section 3.2, which is hereby incorporated by reference herein.

A gNB supports various protocol layers, e.g., Layer 1 (L1)-physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QOS) flows;
Control channels include broadcast control channel (BCCH) and physical control channel (PCCH).

Layer 3 (L3) includes, e.g., radio resource control (RRC), e.g., according to 3GPP™ TS 38.300 V16.6.0 (2021 June) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 11 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

The user equipment (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 11. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment may be in communication with the network system 100.

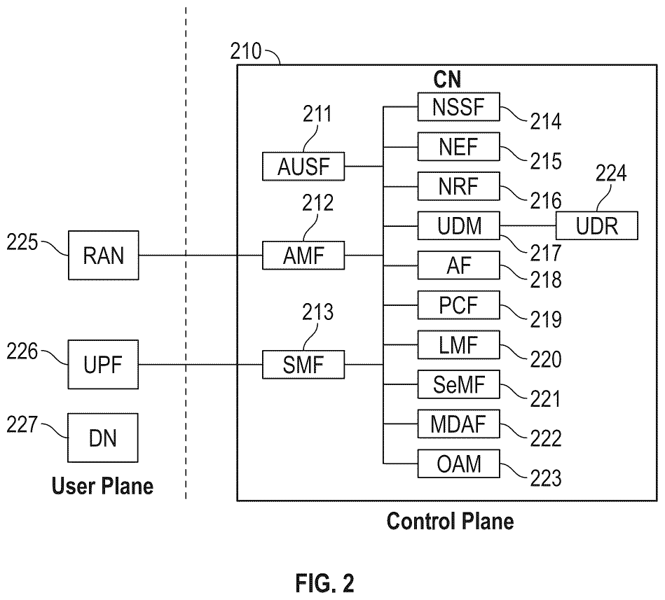

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 includes an authentication server function (AUSF) 211, an access and mobility function (AMF) 212, and a session management function (SMF) 213. The core network 210 also includes a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 include an application function (AF) 218, policy control function (PCF) 219, location management function (LMF) 220, sensing management function (SeMF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The DN 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts packet data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and ADM 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QOS) and charging functionality.

The LMF 220 operates to receive location measurements and location assistance information from the RAN and the UE, via the AMF. The SeMF 221 manages collection of sensing data and will be described in more detail below herein. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

As described above, the sensing management function (SeMF) manages collaboration between wireless network infrastructure and UEs to realize sensing services. In aspects, UEs with sensing capabilities (e.g., IoT devices, smartphones, etc.) may be called upon by the SeMF to perform sensing, and/or to transmit signals for network nodes (e.g., gNB, picocells, femtocells, etc.) to sense, and/or to sense signals transmitted by network nodes (e.g., gNB, picocells, femtocells, etc.). The SeMF may operate as a sensing service provider to application functions in the core network and/or to applications in a UE or other device, which would operate as sensing service consumers.

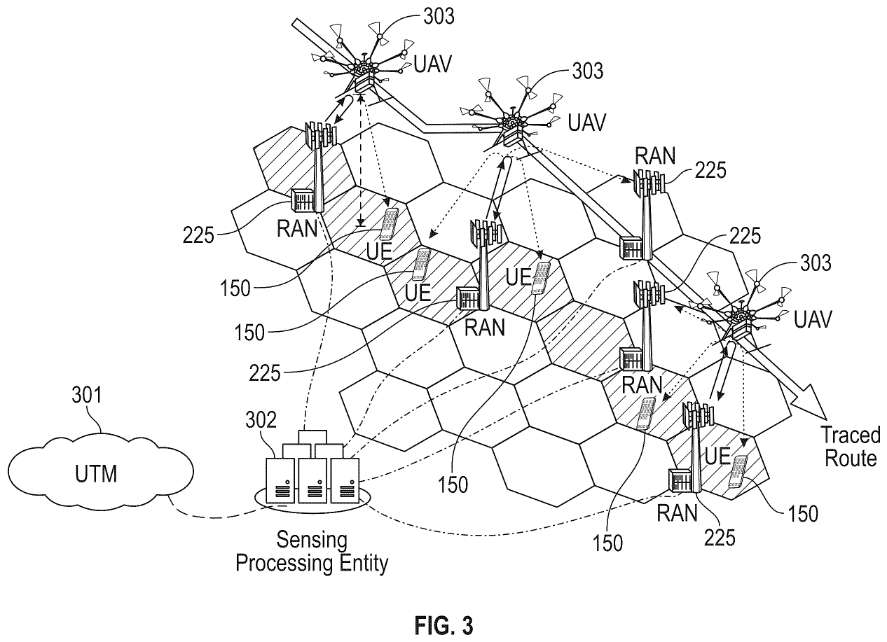

As an example scenario, a 5G network subscriber (e.g., a company) may wish to deploy network nodes (e.g., picocells, femtocells, etc.) and UEs (e.g., IoT devices, etc.) for the subscriber's business sensing needs. In embodiments, the network nodes and UEs may be owned by the subscriber or may be leased from the network operator, and they may have a subscription with the network to use sensing services over the network. The SeMF may provide the sensed data to an application that uses the sensed data for various purposes. With sufficient amounts of sensed data, an application may, for example, use sensed data to obtain awareness of a scene surrounding a user equipment, to detect, localize, and track objects, and/or to form images and/or to extract features for recognition/classification purposes, among other purposes. As used herein, the term “3GPP sensing data” refers to and includes data derived from 3GPP™ radio signals that are impacted (e.g., reflected, refracted, diffracted) by an object or environment of interest for sensing purposes, and that can optionally be processed within the 5G system. 3GPP sensing data is just one type of sensed data contemplated by the present disclosure. Various example uses of sensed data are described in connection with FIGS. 3-5 below.

FIG. 3 is a diagram illustrating an example use case of using sensing services in UAV flight trajectory tracing. FIG. 3 illustrates a radio access network (RAN) 225, which may include network nodes such as gNB, and UEs 150 connected to the RAN 225. In the example of FIG. 3, the network nodes and the UEs 150 may be called upon by the SeMF to provide sensed data, which may then be used by an application, to trace the flight of an unmanned aerial vehicle (UAV) 303. The application may be an application of an unmanned aircraft system traffic management (UTM) system 301. The sensed data provided by the network nodes and/or the UEs 150 may be provided by the SeMF to a sensing processing entity 302, such as a 5G sensing processing entity, which may transmit the sensed data to the UTM system 301. The sensing processing entity 302 may also receive requests for sensed data from the UTM system 301.

For example, a UAV flight may be traced via sensing performed by RAN 225 along the flight trajectory. Apart from acquiring sensed data by a RAN 225 (e.g., gNBs), UEs 150 connected to the RAN 225 can be configured to assist in obtaining sensing data. Potential scenarios in which the UE 150 may aid in obtaining sensed data include, for example, where a UE 150 is a shorter distance away from the UAV than the RAN nodes, and/or where the UE is in the reflection direction with larger radar cross section (RCS) than the RAN nodes. The SeMF may be able to, for example, authorize RAN entities and UEs in certain location areas to generate and report sensed data (e.g., relating to a UAV position, velocity, etc.) to a 5G sensing processing entity 302.

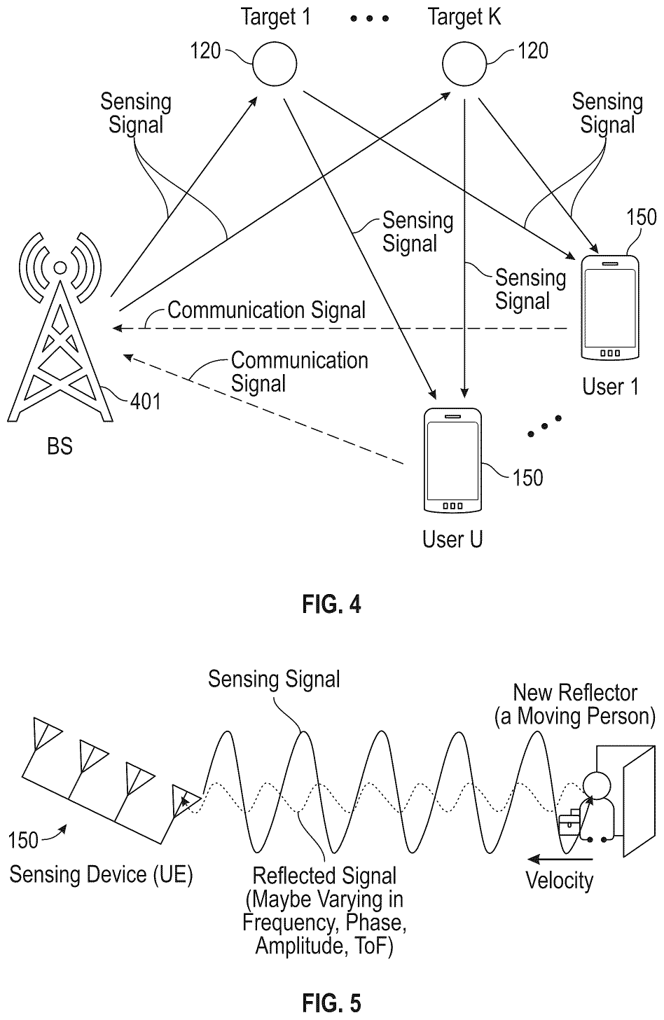

Another use case can include, for example, transparent sensing and spatial mapping/localization, in which sensed data is used to create a spatial (3D) map usable for localizing objects (not shown). UEs in the target area to be 3D-mapped can be involved in producing sensed data in the manner illustrated in FIG. 4. In FIG. 4, the SeMF may support a mechanism to enable RAN nodes 401 and UEs 150 to cooperate to acquire NR-based sensed data to capture information about the nearby environment, such as information about target objects 120 in the environment. In the illustrated embodiment, a RAN node 401 transmits sensing signals (e.g., reference signals), some of which may interact with (e.g., reflect off) the one or more targets 120. The sensing signals resulting from the interactions may be sensed by the UEs 150 as sensed data. The sensed data may be transmitted by the UEs 150 to the network nodes 401 in communication signals, to be used by a service consumer of the SeMF to produce or modify a spatial map.

FIG. 5 illustrates another example use case for detecting an intruder in a home. RAN nodes (e.g., picocell or femtocell, etc.) or UE 150 deployed at or near a home may be used as a sensing signal transmitter, sensing signal receiver, or both. In this scenario, specific RAN node(s) and/or UE(s) 150 in or nearby the home may be selected to perform the transmission or sensing. As shown in FIG. 5, a sensing signal is transmitted and, when it is reflected off a reflector, such as a moving person, the reflected signal may have a frequency, phase, amplitude, or time of flight (ToF) that is different from those of a reference reflected signal or a baseline reflected signal. The different reflected signal characteristics may be sensed as sensed data, which may be used to detect whether an intruder has entered the home.

For the above example use cases of FIGS. 3-5, at least one of the following two sensing methods may be used, with UE(s) cooperation, for the realization of the sensing service: RAN (e.g., a network node) transmits a sensing signal and the UE(s) receives the sensing signal to obtain sensed data; and/or the UE transmits a sensing signal and RAN (e.g., a network node) receives it to obtain sensed data. In this manner, a 5G network subscriber (e.g., a company) who wishes to deploy network nodes (e.g., picocells, femtocells, etc.) and UEs (e.g., IoT devices, etc.) for the subscriber's business sensing needs may provide sensing capabilities over a much larger area (e.g., the coverage area of a 5G network).

In embodiments, various other sensing methods can be used to improve the accuracy of sensing results, such as, without limitation: sensing in a specific geographical region specified using GPS coordinates or in a geographically scoped description (e.g., circular area, rectangular area, ellipsoidal area, or other suitable shape); sensing to a defined side/area of the UE (e.g., the UE serving as a reference point or reference device), e.g., sensing at specific angle of the UE, side of the UE, or 360 degrees around the UE; and/or sensing in a range beyond one or more UEs (e.g., the UE serving as a reference point or reference device). In embodiments, the reference UE/device that is used to define the sensing area can be also the UE that assists in the sensing procedure (i.e., having the role of transmitter of sensing signals or receiver of sensing signals). The sensing method(s) that are employed for a particular scenario may depend on the type of sensing service requested and/or other factors. The examples of FIGS. 3-5 are merely illustrative, and other use cases are contemplated to be within the scope of the present disclosure.

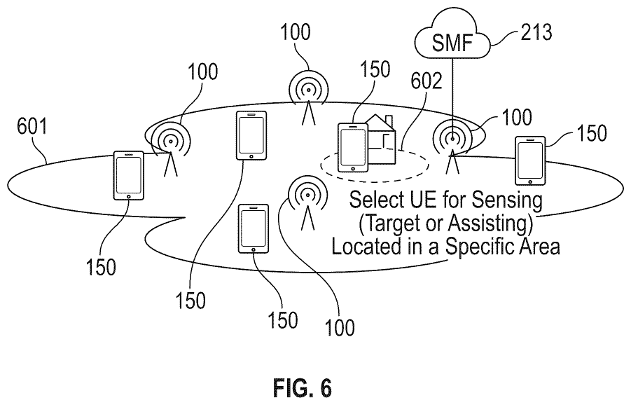

Various examples of infrastructure and use cases were described above. From an implementation standpoint, an SeMF needs to determine which UEs have appropriate sensing capabilities for a sensing request and are also available for fulfilling the sensing request. For example, as shown in FIG. 6, a wireless network may include geographically widespread network nodes and geographically widespread UEs 150. The network nodes and UEs 150 may cover a large region 601, but a sensing request may be directed to a specific area 602. The following describes aspects of the present disclosure relating to registration and selection of UEs with regarding to sensing services.

The following description refers to connection management (CM), which is a protocol used to establish and release the control plane signaling connection between a UE and an AMF. As persons skilled in the art will understand, a UE may have various connection management states, such as a CM-Connected state and a CM-Idle state, which are maintained at non-access stratum (NAS) layer at both UE and AMF. (NAS is a protocol that operates above the access stratum (AS), which deals with the radio interface, and that is responsible for establishing, maintaining, and releasing sessions between the user equipment and the core network.) CM-Idle defines a state in which the UE does not have signaling with the AMF. CM-Idle corresponds to RRC Idle in AS layer. In contrast, CM-Connected means that a UE has a signaling connection with the AMF. When a UE is powered on, it selects the best network node (e.g., gNB) based on cell selection procedure and transmits a registration request to initiate a radio resource control (RRC) connection setup signaling towards the network node (e.g., gNB) and to initiate N2 signaling to the AMF. The registration request triggers the transition from CM-Idle to CM-Connected. If a UE is in CM-Idle state and has to transmit uplink data, the UE triggers a service request NAS message to the AMF and changes from CM-Idle state to CM-Connected state. If there is downlink data to transfer toward a UE that is in CM-Idle state, the network initiates a state transition procedure using a paging message, which triggers the UE to establish RRC connection and to send a service request NAS message to the AMF. The service request triggers a N2 signaling connection, which moves the UE to CM-Connected state. A UE can move from CM-Connected state to CM-Idle state when its signaling connection is released or when its signaling connection fails.

Aspects of the present disclosure relate to enabling the discovery and selection of UEs that are in CM-Connected state and/or in CM-Idle state and could support the sensing requirements of the sensing request from a sensing service consumer.

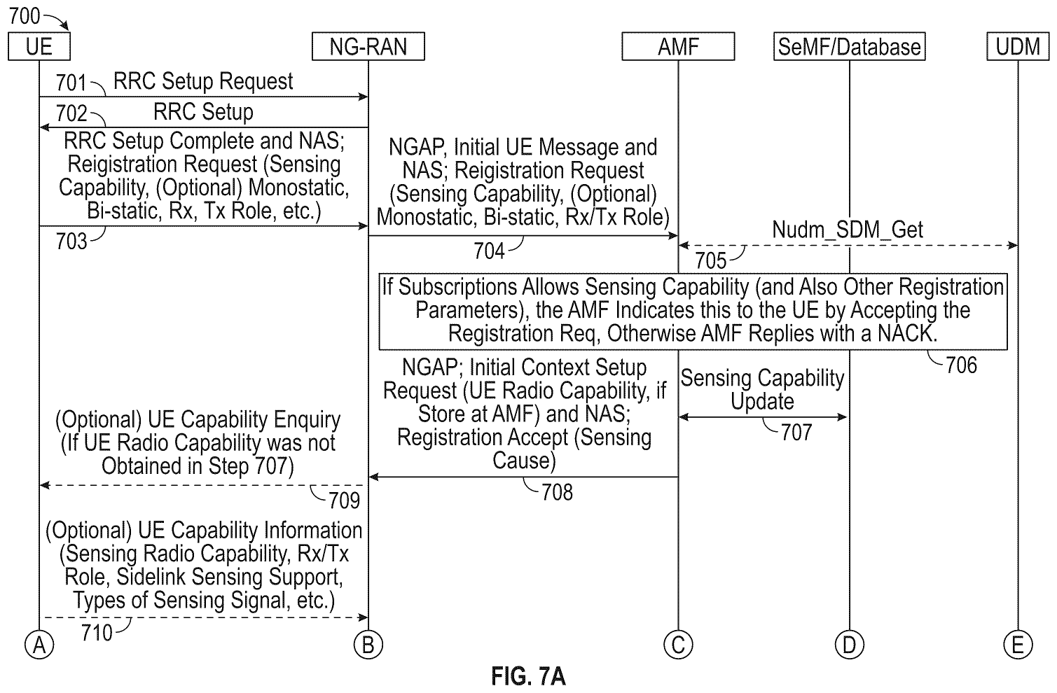

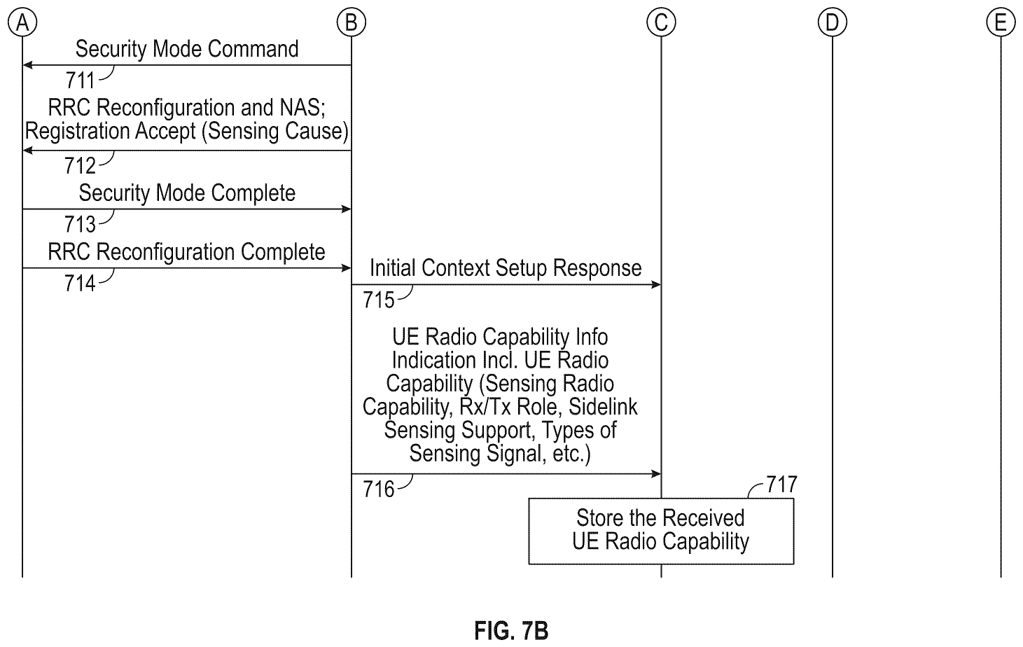

As described in more detail below, a sensing capable UE can indicate its sensing capabilities in a UE capability information message to the RAN, can indicate its sensing capabilities to the AMF in the AN message (as AN parameter), and/or can indicate its sensing capabilities in a new information element in the NAS registration request. These aspects will be described below in connection with FIG. 7A and FIG. 7B.

Referring now to FIG. 7A and FIG. 7B, example signals and operations are disclosed for enabling a network to register UEs and to determine which UEs support sensing capability. As mentioned above, the terms “transmit to”, “receive from”, and “cooperate with” (and their variations), include communications that may or may not involve communications through one or more intermediate devices or nodes. The signals and operations are performed by the components shown at the top of FIG. 7A, which include a user equipment (UE), a NG radio access network (NG-RAN) (e.g., network node), an access and mobility management function (AMF), a sensing management function (SeMF) and a database, and a unified data management function (UDM). Such components may be, for example, the same components described in connection with FIG. 1 and FIG. 2 or otherwise described above.

The following paragraphs describe various signals and operations. It will be understood that the described signals may have associated operations and the described operations may have associated signals. Accordingly, a described signal may also involve an operation and a described operation may also involve a signal.

At operations 701 and 702, the UE and the NG-RAN perform connection establishment procedures. At operation 701 the UE transmits to a radio access network (NG-RAN) (e.g., to a network node) a radio resource control (RRC) setup request, and the NG-RAN receives the RRC setup request from the UE. At operation 702 the NG-RAN transmits, to the UE, an RRC setup message, and the UE receives from the NG-RAN the RRC setup message. Persons skilled in the art will understand connection establishment procedures and RRC setup.

At operation 703, the UE transmits to the NG-RAN an RRC setup complete message. The NG-RAN receives the RRC setup complete message from the UE. The UE encapsulates a non-access stratum (NAS) registration request message in the RRC setup complete message. The UE includes in the NAS registration message an additional information element (IE) indicating its sensing capability and optionally further details such as a supported method (e.g., monostatic configuration, bi-static configuration, and/or Rx/Tx role). As persons skilled in the art will understand, monostatic configuration involves a UE configured to perform both transmit and receive operations, whereas a bistatic configuration involves the transmit operations being performed by a first UE and the receive operations being performed by a second UE. Various sensing capability and sensing methods were described above.

At operation 704, the NG-RAN transmits, to the AMF, the NAS registration request message using NG application protocol (NGAP). The NG-RAN receives, from the AMF, the NAS registration request message, which includes the additional IE indicating the UE's sensing capability and sensing methods.

At operation 705, the AMF may check with the UDM/UDR for the UE subscription details, e.g., for authorization purposes. The operation may invoke the Nudm_SDM Get service operation to retrieve subscription data, which persons skilled in the art will understand.

At operation 706, the AMF determines whether the UE subscription allows sensing capability and services, and determines whether to accept or reject the NAS registration request message. In aspects, the AMF may also check other registration request requirements. If the UE is subscribed to sensing services, the AMF indicates this to the UE by accepting the registration request. Otherwise, the AMF rejects the registration request with a non-acknowledgment (NACK) message.

At operation 707, the AMF may communicate with the sensing management function (SeMF) to update a database that stores the UE's sensing capability and optionally further details such as supported method (e.g., monostatic, bi-static, and/or Rx/Tx role). The AMF may update a database, a repository function, or the SeMF.

At operation 708, the AMF may transmit to the NG-RAN a NGAP initial context setup request message. A NAS registration accept message is encapsulated in the NGAP initial context setup request message. The initial context setup request may include UE radio capability, if that information is available at the AMF. The NG-RAN receives the NGAP initial context setup request message from the AMF. As described above, the NAS registration accept message includes an indication that the AMF has determined the UE is subscribed in sensing services and an indication that the SeMF will cooperate with the UE to provide sensing services.

The NG-RAN may transmit, to the UE, the NAS registration accept message (not shown). In case where the AMF sends registration failure message, the AMF may provide a message indicating the associated reason.

At operation 709, in the case that the UE radio capability was not provided in operation 708, the NG-RAN may transmit, to the UE, a UE radio capability inquiry. The UE receives the UE capability inquiry from the NG-RAN.

At operation 710, the UE transmits, to the NG-RAN, the UE radio capability information message, which includes sensing radio capability, for example, Rx/Tx role, sidelink sensing support, and supported types of sensing signal.

At operation 711, the NG-RAN transmits, to the UE, a security mode command, which persons skilled in the art will understand. The UE receives the security mode command from the NG-RAN.

At operation 712, the NG-RAN transmits to the UE an RRC reconfiguration request and NAS registration request accept message. The NAS registration accept message may be encapsulated in the RRC reconfiguration message and informs the UE whether sensing-related registration is successful, or if not, the reason for failure. The UE receives from the NG-RAN the RRC reconfiguration request.

At operation 713, the UE responds by transmitting a security mode complete message to the NG-RAN, and the NG-RAN receives the security mode complete message from the UE.

At operation 714, the UE transmits an RRC reconfiguration complete message to the NG-RAN, and the NG-RAN receives the RRC reconfiguration complete message from the UE.

At operation 715, the NG-RAN transmits to the AMF an initial context setup request, and the AMF receives the initial context setup request form the NG-RAN. Persons skilled in the art will understand the details of operations 711-715.

At operation 716, the UE radio capability, which was reported from the UE to the NG-RAN in operation 710, is transmitted to the AMF, and the AMF receives the UE radio capability from the NG-RAN.

At operation 717, AMF stores the received UE radio capability for later recall and use.

In embodiments, sensing capabilities that may be included in the NAS registration request message in operation 703, or in the RRC UE capability information message in operation 710, or exchanged as UE sensing capability information, may include one or more of the following: local processing capability of sensing measurements/data, UE Obfuscation capability on sensing measurements/data, indication of parameters/features/types of sensing data that can be collected by the UE and if available information about the granularity of collected sensing data, indication of supported sensing services, indication on sensing using UL and/or DL pilot or reference signals for channel parameter estimation, indication on sensing using data or user plane signals for channel parameter estimation, indication of the (maximum) number of sensing resources (e.g., DL and/or UL sensing reference signals, data or user plane signals) supported by the respective UE ID (UE identified by ID), per sensing frequency layer, indication of available sensing resources, indication of (number of) sensing frequency layers on a certain frequency band, indication of supported frequency band for sensing (e.g., central frequency, bandwidth, 3GPP™ NR FR1 (n1, n3, n77, etc.), 3GPP™ NR FR2 (n257, n258, etc.)) or supported frequency range for sensing (e.g., 600 MHz to 6 GHZ, 24 GHz to 71 GHz), supported radio access technology for sensing, max Tx power, supported bandwidth, and/or sensing signal interval, among others.

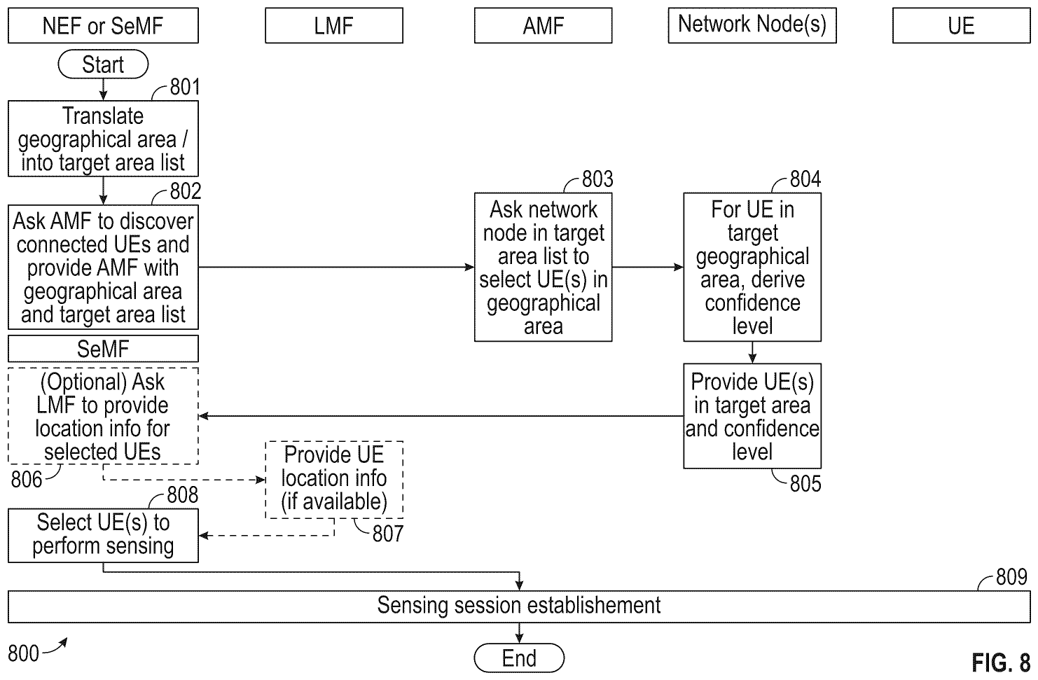

In the manner described above, a UE may register with a core network to participate in sensing services and may indicate to or update the core network on the UE's sensing and radio capabilities. Such information may be usable later in connection with sensing services, as described below in connection with FIG. 8.

The operations of FIG. 7A and FIG. 7B are merely illustrative, and variations are contemplated to be within the scope of the present disclosure. In embodiments, the operations may include others not illustrated in FIG. 7A and FIG. 7B. In embodiments, the operations may not include every signal and operation illustrated in FIG. 7A and FIG. 7B. In embodiments, the operations may be implemented in a different order than that illustrated in FIG. 7A and FIG. 7B. Such and other embodiments are contemplated to be within the scope of the present disclosure.

A result of the operations of FIGS. 7A/7B is that a plurality of UEs may be registered with a core network in connection with sensing services. Referring now to FIG. 8, there is shown an exemplary approach for selecting UEs that are in CM-Connected state to perform sensing in a target sensing area, so that a SeMF can establish a sensing session involving UEs within the target sensing area as requested by an AF or by an application (of a UE or otherwise). Aspects of FIG. 8 are intended to be usable with aspects of FIG. 7A and FIG. 7B. As mentioned above, the terms “transmit to”, “receive from”, and “cooperate with” (and their variations), include communications that may or may not involve communications through one or more intermediate devices or nodes. The signals and operations are performed by the components shown at the top of FIG. 8, which include a network exposure function (NEF) or sensing management function (SeMF), a location management function (LMF), an access and mobility management function (AMF), a radio access network (RAN) (e.g., network nodes), and a user equipment (UE). Such components may be, for example, the same components described in connection with FIG. 1 and FIG. 2 or otherwise described above.

The following paragraphs describe various signals and operations. It will be understood that the described signals may have associated operations and the described operations may have associated signals. Accordingly, a described signal may also involve an operation and a described operation may also involve a signal.

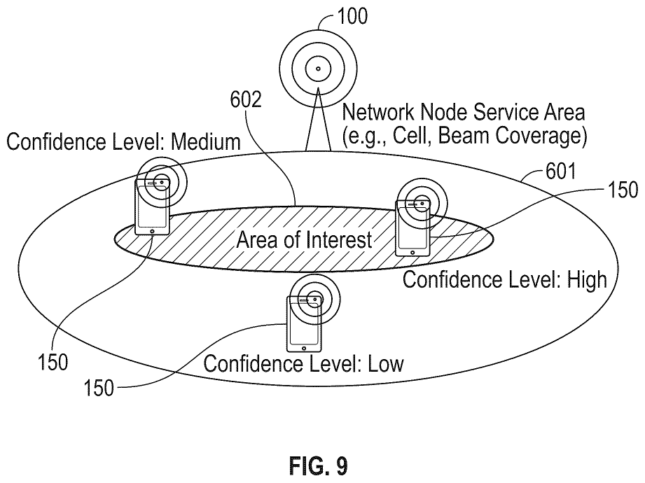

At operation 801, if a sensing area of interest (e.g., 602, FIG. 9) (i.e., a geographical area to perform sensing) is provided by an application function (AF) or by an application in a sensing request, the network exposure function (NEF) or the SeMF maps the received sensing area of interest to a list of target areas that cover the sensing area of interest 602. As used herein, the term “target area” refers to and includes a geographical area served by sensing services. In embodiments, a target area may be a defined geographic area. In embodiments, a target area may correspond to the coverage area of a cell or the coverage area comprised of multiple cells, e.g., Tracking Area. In embodiments, the target area may correspond to the area over which a fixed-location UE may be able to communicate for sensing services. In embodiments, a target area can be defined by a subscriber or a Mobile Network Operator. Such embodiments are merely examples, and other target areas are contemplated to be within the scope of the present disclosure.

At operation 802, the NEF and/or SeMF transmit a request to the AMF to discover UEs that are in CM-Connected state and which are located in the target areas. The AMF receives the request from the NEF and/or SeMF. The request message conveyed to the AMF may include one or more of the following information: sensing area of interest (as requested by AF or application); the list target areas which cover the sensing area of interest; a target UE state to select (in this case, CM-Connected state); a UE selection criteria (e.g., a sensing confidence level that is greater than a configurable threshold, target UE communication speed (e.g., less than or greater than a configured speed, target UE type (e.g., stationary UE, road side unit (RSU), etc.)); and/or target sensing method(s) which the selected UE needs to support, among other information.

At operation 803, the AMF transmits a request to one or more network nodes in the target areas to provide a list of candidate UEs (e.g., in CM-Connected state), and the network node(s) receive the request from the AMF. In embodiments, the AMF transmits the request to network nodes that include one or more cells serving the target areas. The request message transmitted to the network node(s) may include a sensing area of interest (as forwarded from SeMF); UE selection criteria (e.g., the confidence level is greater than a configurable threshold, target UE communication speed (less than or greater than a configurable speed, target UE type (e.g., stationary UE, RSU, etc.)); and/or Target sensing method(s) which the selected UE needs to support, among other information.

At operation 804, the network node(s) determine a confidence level for UEs in the target areas.

To address the scenario where the sensing target area (i.e., area of interest for sensing) is smaller than the size of a cell or beam, a confidence level may be calculated for each UE (e.g., in CM-Connected state) in the vicinity of the sensing area of interest. The confidence level may indicate a relative distance of a UE, for example, with respect to a sensing signal transmitting entity (e.g., a gNB) and relates to UEs suitability to effectively assist in obtaining sensed data. In embodiments, a confidence level requirement may be that UE should be located within the area of interest. In embodiments, the confidence level can be denoted by indicators, such as {high, medium, low}, or can be expressed as a probability, e.g., from 0% to 99%. FIG. 9 illustrates an example of the confidence level denoted by indicators (e.g., high, medium, low). Although high medium and low are used as examples, other suitable manners of indicating confidence levels are contemplated. The network node(s) (e.g., a CU) determines the confidence level for UEs connected to its serving cells. In embodiments, the confidence levels may be determined by respective network nodes.

In embodiments, a network node (e.g., eNB/gNB) may store UE radio capability for all RRC_Connected UEs connected to the network node. The network node may select the RRC_Connected UEs that are capable of sensing. If target sensing method(s) are indicated by the AMF in the request message in operation 803, the network node(s) may select the UEs by first checking whether the UEs support the target sensing method(s). For each selected UE, the network node calculates a confidence level for the target areas received in operation 803. To derive the confidence level, a base station can leverage information on the direction and coverage of a beam (e.g., signal synchronization block (SSB), channel state information-reference signal (CSI-RS), etc.) over which a UE transmits and receive data. The network node can also use measurements results reported by UE (e.g., reference signal received power (RSRP), reference signal received quality (RSRQ), signal interference and noise ratio (SINR), etc.) and its own measurements obtained by UL signaling from UE (e.g., sounding reference signal (SRS), etc.). If UE selection criteria are received from the AMF in operation 803, the selected RRC Connected UE's may be further narrowed down to those UEs which fulfill all the criteria.

At operation 805, the network node transmits, to the SeMF via the AMF, the list of selected UEs. Each selected UE is indicated by its UE ID, e.g., a shortened temporary mobile subscriber identity (S-TMSI). For each selected UE, the report message to the AMF includes the estimated confidence level and may include DL/UL measurement results, if available (e.g., RSRP, RSRP, and/or SINR).

At operation 806, the SeMF may optionally transmit a request to the LMF to provide location information for the UEs selected in operation 805, and the LMF receives the request from the SeMF.

At operation 807, the LMF may optionally transmit to the SeMF the UE location information in response to the request, and the SeMF receives the location information.

At operation 808, the SeMF selects UE(s) to perform sensing from the UE list provided in operation 805.

At operation 809, the SeMF establishes a sensing session involving the selected UE(s) in operation 808 to perform sensing.

The operations of FIG. 8 are merely illustrative, and variations are contemplated to be within the scope of the present disclosure. In embodiments, the operations may include others not illustrated in FIG. 8. In embodiments, the operations may not include every signal and operation illustrated in FIG. 8. In embodiments, the operations may be implemented in a different order than that illustrated in FIG. 8. Such and other embodiments are contemplated to be within the scope of the present disclosure.

FIG. 9 shows an example of a scenario where various UEs 150 have different confidence levels with respect to a sensing area of interest 602. The UEs 150 are served by a network node 100, which has a coverage area 601 that is larger than the sensing area of interest 602. Applying the operations shown in FIG. 8, the network node 100 may determine a confidence level for each UE that may be able to provide sensing services. The network node 100 may determine that one UE has a low confidence level based on various criteria mentioned in connection with FIG. 8, and determine that another UE has a medium confidence level, and determine that yet another UE has a high confidence level. The illustrated scenario is merely an example, and scenarios with any number of network nodes, any number of UEs, and/or any number of target areas, are contemplated to be within the scope of the present disclosure.

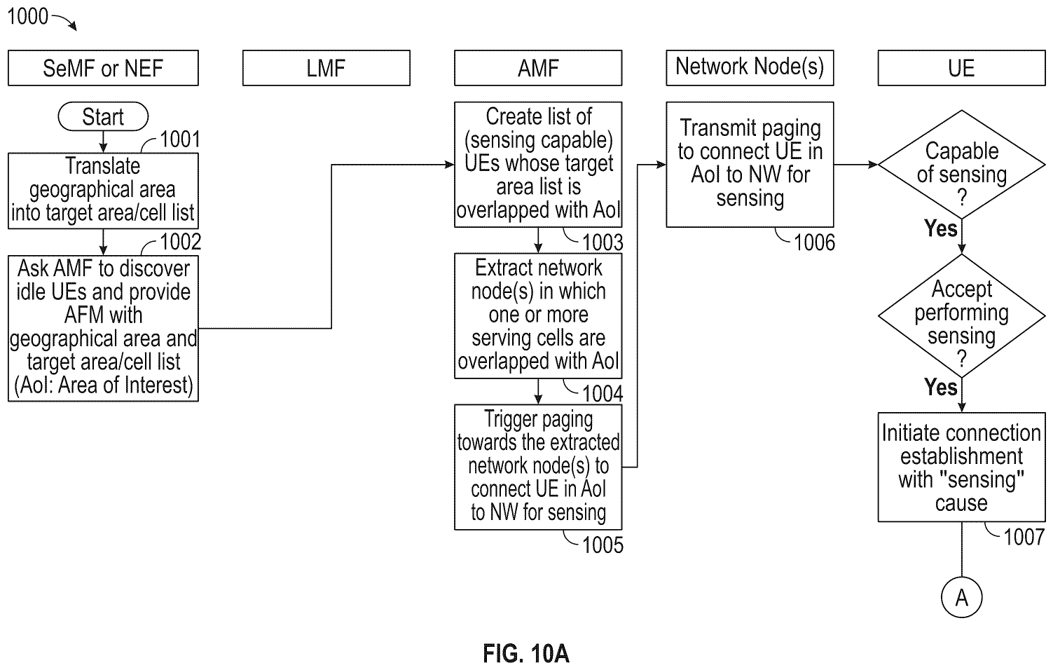

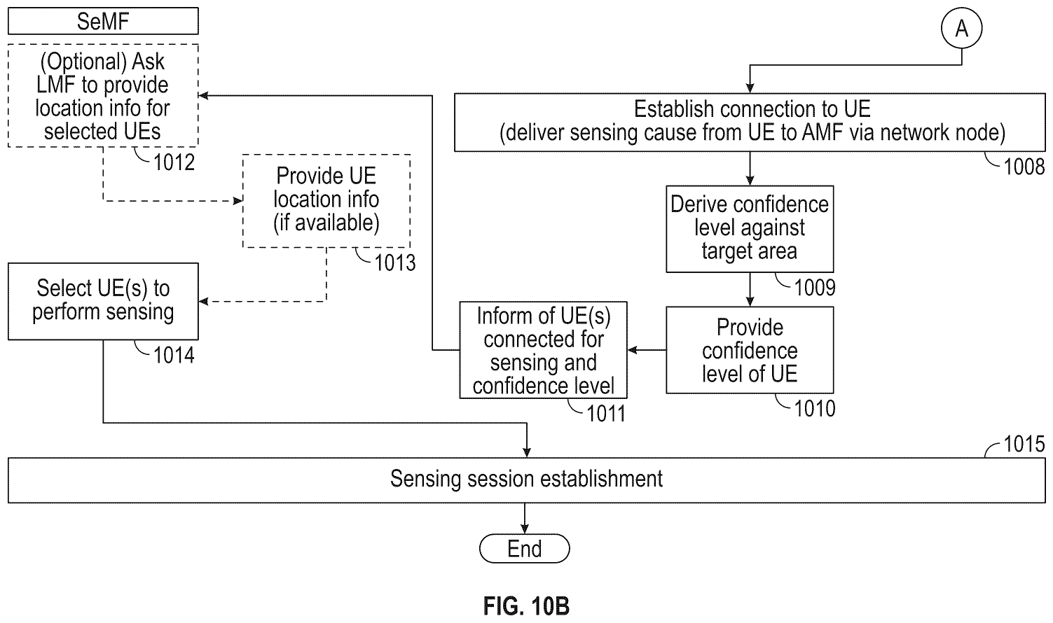

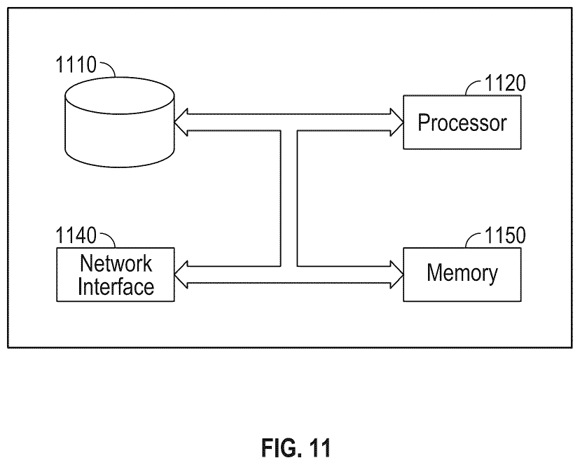

FIG. 8 showed an example approach for selecting UEs (e.g., that are in CM-Connected state) to perform sensing in a target sensing area. Referring now to FIG. 10A and FIG. 10B, there is shown an example approach for selecting UEs that are in CM-Idle state to perform sensing in a target sensing area, so that a SeMF can establish a sensing session involving UEs within the target sensing area as requested by an AF or by an application (of a UE or otherwise). Notably, when a UE is in the CM-Idle state, the UE has no NAS signaling connection established with the AMF over the N1 interface. Aspects of FIG. 10A and FIG. 10B are intended to be usable with aspects of FIG. 7A, FIG. 7B, and FIG. 8. As mentioned above, the terms “transmit to”, “receive from”, and “cooperate with” (and their variations), include communications that may or may not involve communications through one or more intermediate devices or nodes. The signals and operations are performed by the components shown at the top of FIG. 10A, which include a network exposure function (NEF) or sensing management function (SeMF), a location management function (LMF), an access and mobility management function (AMF), a radio access network (RAN) (e.g., network nodes), and a user equipment (UE). Such components may be, for example, the same components described in connection with FIG. 1 and FIG. 2 or otherwise described above.

The following paragraphs describe various signals and operations. It will be understood that the described signals may have associated operations and the described operations may have associated signals. Accordingly, a described signal may also involve an operation and a described operation may also involve a signal.

The method of FIGS. 10A/10B rely on an AMF being aware of the target areas in which UEs may be able to obtain sensed data. As described above, a “target area” refers to and includes a geographical area served by sensing services and may include defined geographical areas, among other possibilities. The AMF may have this awareness based on the UE being registered with the network (e.g., initial registration, mobility registration update, etc.) and having the UE's geographic location as part of the registration process. The AMF may then associate the UE with one or more target areas based on the UE's geographic location. As described below, an AMF can select CM-Idle UEs whose associated target area(s) are at least partially overlapped with a sensing area of interest (e.g., 602, FIG. 9). The disclosed approach attempts to not transmit a paging message to UEs that are not located in the sensing area of interest, as paging and causing such UEs to enter CM-Connected state may result in consuming UE power unnecessarily as well as incurring unnecessary signaling load due to connection setup. Rather, the disclosed approach transmits the paging message within the sensing area of interest and provides the potential benefit of not consuming UE power unnecessarily as well as the potential benefit of not incurring unnecessary signaling load.

Before operation 1001, an AF or an application (in a UE or otherwise) transmits to the SeMF and/or the NEF a sensing request that specifies a sensing area of interest (“AoI”). The SeMF and/or the NEF receives the sensing request including the sensing area of interest (e.g., 602, FIG. 9) from the AF or from the application (in a UE or otherwise).

At operation 1001, the SeMF and/or the NEF maps the received sensing area of interest to a list of target areas which cover the sensing area of interest.

At operation 1002, the SeMF and/or the NEF transmits, to the AMF, a request to discover UE's in CM-Idle state which are located in the sensing area of interest. The AMF receives the request message from the SeMF and/or the NEF. The request message conveyed to AMF may include at least one of the following information: the sensing area of interest; the list target area(s) which cover the sensing area of interest; the target UE state to select (in this case, CM-Idle state); the UE selection criteria (e.g., the confidence level is greater than a configurable threshold, target UE communication speed (e.g., less than or greater than a configurable speed, target UE type (e.g., stationary UE, RSU, etc.)); the target sensing method(s) which the selected UE needs to support; and/or a number of UEs required to perform sensing in order to fulfill the requirement and QoS as per the sensing request, among other possible information.

At operation 1003, the AMF creates a list of sensing capable UEs whose associated target areas overlap with at least one target area of the list of target areas provided in operation 1002. In a case where the AMF stores the UE sensing capability, such information may be taken into account when selecting UEs at operation 1003. If the target sensing method(s) is provided in operation 1002, the AMF selects the UE(s) which support the target sensing method(s).

At operation 1004, the AMF identifies network nodes which have one or more serving cells that at least partially overlap with the sensing area of interest.

At operation 1005, the AMF triggers paging towards the UEs identified in operation 1003. The paging message is transmitted only to the network nodes identified in operation 1004, and such network nodes receive the paging message. The paging approach may be denoted as “sensing assisted paging.” The characteristics and message contents of sensing assisted paging will be shown in more detail later herein. For now, it is sufficient to note that the paging request message from the AMF to the network node may include one or more of the following: paging record(s) that include UE ID (e.g., S-TMSI) identified in operation 1003; the sensing area of interest (as forwarded from SeMF); the target sensing method(s) which the selected UE needs to support (included if UE capability of sensing was not taken into account in operation 1003).

With continuing reference to operation 1005, the AMF may in embodiments, trigger paging without identifying UEs in operation 1003. Such embodiments are intended to page any sensing capable UEs in the sensing area of interest, with the benefit of skipping operation 1003, to search for UEs present in the target areas. In such embodiments, the paging request message from the AMF to the network node may include at least one of the following: an indication to page any sensing capable UEs; the sensing area of interest (as forwarded from SeMF); and/or the target sensing method(s) which the selected UE needs to support.

At operation 1006, upon receiving the paging message from the AMF, the network node(s) transmit a paging message over the cells obtained from the AMF in operation 1005. The paging message may include one or more of the following: paging record(s) that include UE ID (e.g., S-TMSI) obtained from AMF in operation 1003 or an indication to page any sensing capable UEs received from AMF in operation 1004; and/or target sensing method(s) which the selected UE needs to support.

At operation 1007, the UEs receive the paging message transmitted in operation 1006. If the UE is capable of the requested sensing, or if the target sensing method(s) are indicated in the paging message and the UE accepts performing sensing as a sensing transmitter or as a sensing receiver, the UE initiates to setup the RRC connection and transmits the RRC connection setup request to network node. The UE indicates the establishment cause as “sensing” in the RRC connection setup request message.

At operation 1008, the connection is set up between the AMF and the UE via the network node. The establishment cause of “sensing” is transmitted to the AMF from the UE via the network node, and received by the AMF from the UE.

At operation 1009, the network node determines the confidence level as in operation 804 of FIG. 8.

At operation 1010, the network node transmits to the AMF the estimated confidence level for the UE, and the AMF receives from the AMF the estimated confidence level for the UE. The network node may also transmits to the AMF downlink and uplink (DL/UL) measurement results if available (e.g., RSRP, RSRP, and/or SINR).

At operation 1011, the AMF transmits to the SeMF a message to inform the SeMF of UE(s) connected for sensing and their estimated confidence level, as well as DL/UL measurement results, if provided by the network node. The SeMF receives the message from the AMF.

At operation 1012, the SeMF may optionally transmit a request to the location management function (LMF) to provide location information for the selected UEs. The LMF receives the request from the SeMF.

At operation 1013, the LMF may optionally transmit to the SeMF the UE location information if available. The SeMF receives from the LMF the location information.

At operation 1014, the SeMF selects UE(s) to perform sensing from the UE list provided in operation 1011.

At operation 1015, a sensing session is established involving the UE(s) selected in operation 1014 to perform sensing.

Accordingly, FIG. 10 disclosed an approach for identifying CM-Idle UEs for providing sensing services in a geographical area of interest. As mentioned above, the disclosed approach may involve sensing assisted paging, which may be specified in 3GPP™ TS 38.413 relating to NGAP. In embodiments, sensing assisted paging may involve the following aspects.

In embodiments, the purpose of sensing assisted paging procedure is to enable the AMF to page a sensing capable UE served by a NG-RAN node whose serving cell coverage is at least partially overlapped with the sensing area of interest.

In embodiments, the AMF initiates the sensing assisted paging procedure by sending a SENSING ASSISTED PAGING message to the NG-RAN node. At the reception of the SENSING ASSISTED PAGING message, the NG-RAN node performs paging over the cell(s) which are overlapped or partially overlapped with a Paging Area IE.

If the Paging DRX IE is included in the SENSING ASSISTED PAGING message, the NG-RAN node shall use it according to TS 38.304, which is hereby incorporated by reference herein in its entirety.

If the UE Paging List IE is included in the SENSING ASSISTED PAGING message, the NG-RAN node shall, if supported, use it according to TS 38.304. If absent, the NG-RAN node shall perform paging for any UEs capable of sensing within the Paging Area IE.

In embodiments, the SENSING ASSISTED PAGING message is sent by the AMF and is used to notify sensing capable UEs about the activation of a UE assisted sensing. In embodiments, the message may have the following information elements:

| IE/Group Name | Range | IE type and reference |
|---|---|---|
| Message Type | | TS 38.413, 9.3.1.1 |
| UE Paging List | 0..1 | |
| >UE Paging Item | 1..<maxnoofUEsforPaging> | |
| >>UE Paging Identify | | TS 38.413, 9.3.3.18 |
| Paging DRX | | TS 38.413, 9.3.1.90 |
| CHOICE Paging Area | | |
| >TAI List for Paging | 1 | |
| >>TAI List for Paging | 1..<maxnoofTAIforPaging> | |
| Item | | |
| >>>TAI | | TS 38.413, 9.3.3.11 |
| >Area of Interest List for | 1 | |
| Sensing | | |
| >>Area if Interest List | 1..<maxnoofAoIforPaging> | |
| for Sensing | | |
| >>>NR CGI | | TS 38.413, 9.3.1.7 |
| Target Sensing Method | | ENUMERATED |
| | | (uplinkTxSensing, |
| | | downlinkRxSensing, |
| | | sidelinkTxSensing, sidelinkRxSensing, |
| | | sidelinkRxTxSensing, ...) |

The range parameters shown above may have the following meanings:

| Range bound | Explanation |
|---|---|
| maxnoofTAIforPaging | Maximum no. of TAIs for sensing assisted |
| | paging. |
| maxnoofAoIforPaging | Maximum no. of Area of Interests for sensing |
| | assisted paging. |
| maxnoofUEsforPaging | Maximum no. of UEs to page. |

In embodiments, a paging record in the SENSING ASSISTED PAGING message may have one or more of the following fields:

accessType: Indicates whether the Paging message originated due to the PDU sessions from the non-3GPP™ access.

pagingAnySensingUE: Indicates whether any sensing capable UEs are paged. If this field is present, the UE discards and ignore the pagingRecordList, if present.

pagingRecordList: If the network includes pagingRecordList-v1700, it includes the same number of entries, and listed in the same order, as in pagingRecordList (i.e., without suffix).

pagingCause: Indicates whether the Paging message originated due to IMS voice. If this field is present, it implies that the corresponding paging entry is for IMS voice. If upper layers indicate the support of paging cause and if this field is not present but pagingRecordList-v1700 is present, it implies that the corresponding paging entry is for a service other than IMS voice. Otherwise, paging cause is undetermined.

targetSensingMethod: Indicates the target sensing method that UE is expected to assist sensing.

In embodiments, the paging record may include one or both of pagingAnySensingUE or targetSensingMethod.

The information elements (IEs), records, and fields described are merely examples, and variations are contemplated to be within the scope of the present disclosure. For example, the IEs, records, and fields may have different names than the ones described above.

The operations of FIG. 10A and FIG. 10B are merely illustrative, and variations are contemplated to be within the scope of the present disclosure. In embodiments, the operations may include others not illustrated in FIG. 10A and FIG. 10B. In embodiments, the operations may not include every signal and operation illustrated in FIG. 10A and FIG. 10B. In embodiments, the operations may be implemented in a different order than that illustrated in FIG. 10A and FIG. 10B. Such and other embodiments are contemplated to be within the scope of the present disclosure.

Accordingly, the description above relating to FIGS. 7A-10B disclosed operations of various entities. The following will describe operations from the perspective of particular entities.

From the perspective of an SeMF, the SeMF performs one or more of the following operations: requesting AMF to discover UEs in CM-Connected and/or CM-Idle state; requesting UEs that are located in the sensing area of interest; providing UE selection criteria and information that can be used to configure the discovery procedure; selecting the UEs that could support a sensing procedure according to one or more of the following: sensing service request requirements, UEs sensing capabilities, discovered UEs in CM-Connected or CM-Idle state in a specific area, radio related parameters of discovered UEs, and/or sensing related information provided by RAN/AMF for discovered UEs.

From the perspective of an AMF, the AMF performs one or more of the following operations: receiving and storing sensing capability of the UEs; transmitting or updating received UE sensing capabilities, to a database or to a repository function or to SeMF or to any other NF, wherein UE sensing capabilities include each UE's sensing capability and optionally further details such as supported sensing method (e.g., monostatic, bi-static, Rx/Tx role, etc.); requesting RAN entities (e.g., network node) to provide a list of candidate UEs in CM-Connected state, including UE selection criteria and information that can be used to configure the discovery procedure; identifying UEs in CM-Idle state whose associated target are at least partially overlapped with the sensing area of interest obtained from SeMF and respective network nodes having one or more serving cells whose coverage is at least partially overlapping with the sensing area of interest; transmitting a paging message that is transmitted towards identified network nodes, including paging information such as UE ID (S-TMSI), sensing area of interest (as determined at SeMF), target sensing method(s) which the selected UE needs to support; transmitting list of discovered/selected UEs, including the ID of each selected UE, estimated confidence level for each UE and other radio information that could be relevant for sensing procedures (e.g., DL/UL measurement results such as RSRP, RSRP, SINR, etc.).

From the perspective a core network, the receiving, by one or more components of a core network, a message comprising information indicating one or more sensing capabilities of a user equipment (UE); transmitting, by one or more components of the core network, one of the following: an indication that the UE is registered in connection with sensing services provided by one or more components of the core network, or an indication that the UE is not registered in connection with the sensing services provided by one or more components of the core network.

From the perspective of a RAN, the RAN performs one or more of the following operations: requesting the UE to provide the sensing related UE radio capability; forwarding to the AMF or any other NF (e.g., SeMF) the sensing related UE radio capability reported from UE; identifying one or more UEs relevant for a received sensing request and the respective UE selection criteria and sensing related information; determining the confidence level of one or more UEs in a defined sensing area of interest, wherein the confidence level provides an indication about the level of trust/confidence of the network node on the estimation that the UE matches/fulfills one or more of the UE selection criteria; transmitting to the SeMF or to the AMF the list of discovered/selected UEs, including the ID of each selected UE, estimated confidence level for each UE and other radio information that could be relevant for sensing procedures (e.g., DL/UL measurement results such as RSRP, RSRP, SINR, etc.); upon receiving the paging request from AMF, transmitting a paging message over the cells within the sensing area of interest determined at the AMF, including sensing relevant paging information.

For example, from the perspective of the RAN, the method includes receiving, by one or more components of a radio access network (RAN), a message comprising information indicating one or more sensing capabilities of a user equipment (UE); transmitting, by one or more components of the RAN, one of the following: an indication that the UE is registered in connection with sensing services provided by one or more components of a core network, or an indication that the UE is not registered in connection with the sensing services provided by one or more components of the core network.

From the perspective of a UE, the UE performs one or more of the following operations: UE includes in the NAS registration message (e.g., as part of RRC setup complete message) additional IE indicating its sensing capability and optionally further details such as supported method e.g., monostatic, bi-static, Rx/Tx role, etc.; UE transmits the UE capability information message which includes sensing radio capability (e.g., Rx/Tx role, sidelink sensing support, supported types of sensing signal, etc.) to the network node and/or AMF or any other NF; upon receiving a paging message, the UE checks whether sensing is indicated in the message or sensing related information, message, and whether to participate in sensing procedure (e.g., sensing transmission or a sensing reception); sets up an RRC connection and transmits an RRC connection setup request to network node and then to AMF, indicating the establishment cause of “sensing” in the RRC connection setup request message.

For example, from the perspective of the UE, the method includes transmitting, by a user equipment (UE), to one or more components of a core network, a message comprising information indicating one or more sensing capabilities of the UE; and receiving, by the UE, one of the following: an indication that the UE is registered in connection with sensing services provided by one or more components of the core network, or an indication that the UE is not registered in connection with the sensing services provided by one or more components of the core network.

Referring now to FIG. 11, there is shown a block diagram of example components of a UE or a network apparatus. The apparatus includes an electronic storage 1110, a processor 1120, a memory 1150, and a network interface 1140. The various components may be communicatively coupled with each other. The processor 1120 may be and may include any type of processor, such as a single-core central processing unit (CPU), a multi-core CPU, a microprocessor, a digital signal processor (DSP), a System-on-Chip (SoC), or any other type of processor. The memory 1150 may be a volatile type of memory, e.g., RAM, or a non-volatile type of memory, e.g., NAND flash memory. The memory 1150 includes processor-readable instructions that are executable by the processor 1120 to cause the apparatus to perform various operations, including those mentioned herein, such as the operations of FIGS. 3-10.

The electronic storage 1110 may be and include any type of electronic storage used for storing data, such as hard disk drive, solid state drive, and/or optical disc, among other types of electronic storage. The electronic storage 1110 stores processor-readable instructions for causing the apparatus to perform its operations and stores data associated with such operations, such as storing data relating to 5G NR standards, among other data. The network interface 1140 may implement wireless networking technologies such as 5G NR and/or other wireless networking technologies.

The components shown in FIG. 11 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1.1 A user equipment comprising:
at least one processor; and
at least one memory storing instructions which, when executed by the at least one processor, cause the user equipment at least to perform:
   transmitting, by a user equipment (UE), to one or more components of a core network, a message comprising information indicating one or more sensing capabilities of the UE; and
   receiving, by the UE, one of the following:
      an indication that the UE is registered in connection with sensing services provided by one or more components of the core network, or
      an indication that the UE is not registered in connection with the sensing services provided by one or more components of the core network.

Example 1.2. The user equipment of Example 1.1, wherein the message is a registration request configured to register the UE with an access and mobility management function (AMF) of the core network,
wherein the registration request comprises the information indicating the one or more sensing capabilities of the UE.

Example 1.3. The user equipment of Example 1.1 or Example 1.2, wherein the message further comprises information indicating at least one of the following:
the UE capable of operation in a monostatic mode for the sensing service,
the UE capable of operating in a bistatic mode for the sensing services,
the UE capable of a transmission role for the sensing services,
the UE capable of a reception role for the sensing services,
the UE capable of sidelink sensing for the sensing services, or
at least one type of sensing signal that the UE is capable of at least one of: receiving or transmitting.

Example 1.4. The user equipment of any of Example 1.1-1.3, wherein the indication, that the UE is registered in connection with the sensing services provided by one or more components of the core network, is an indication that the UE is subscribed to the sensing services.

Example 1.5. The user equipment of any of Example 1.1-1.4, wherein the indication, that the UE is not registered in connection with the sensing services provided by one or more components of the core network, is an indication that the UE is not subscribed to the sensing services.

Example 1.6. The user equipment of any of Example 1.1-1.5, wherein the instructions, when executed by the at least one processor, further cause the user equipment at least to perform:
receiving, by the UE while in connection management-idle (CM-Idle) state, based on the indication that the UE is registered in connection with the sensing services, a paging message in connection with the sensing service, wherein the paging message comprises a request for a sensing method.

Example 1.7. The user equipment of Example 1.6, wherein the instructions, when executed by the at least one processor, further cause the user equipment at least to perform:
determining, by the UE, whether the UE is capable of the sensing method; and
based on the determining, one of the following:
   accepting the request for the sensing method, or
   declining the request for the sensing method.

Example 1.8. The user equipment of Example 1.7, wherein the instructions, when executed by the at least one processor, further cause the user equipment at least to perform:
initiating connection establishment for changing, by the UE, based on the accepting the request for the sensing method, from the CM-Idle state to a connection management-connected (CM-Connected) state.

Example 2.1 A user equipment comprising:
means for transmitting, by a user equipment (UE), to one or more components of a core network, a message comprising information indicating one or more sensing capabilities of the UE; and
means for receiving, by the UE, one of the following:
   an indication that the UE is registered in connection with sensing services provided by one or more components of the core network, or
   an indication that the UE is not registered in connection with the sensing services provided by one or more components of the core network.

Example 2.2. The user equipment of Example 2.1, wherein the message is a registration request configured to register the UE with an access and mobility management function (AMF) of the core network,
wherein the registration request comprises the information indicating the one or more sensing capabilities of the UE.

Example 2.3. The user equipment of Example 2.1 or Example 2.2, wherein the message further comprises information indicating at least one of the following:
the UE capable of operation in a monostatic mode for the sensing service,
the UE capable of operating in a bistatic mode for the sensing services,
the UE capable of a transmission role for the sensing services,
the UE capable of a reception role for the sensing services,
the UE capable of sidelink sensing for the sensing services, or
at least one type of sensing signal that the UE is capable of at least one of: receiving or transmitting.

Example 2.4. The user equipment of any of Example 2.1-2.3, wherein the indication, that the UE is registered in connection with the sensing services provided by one or more components of the core network, is an indication that the UE is subscribed to the sensing services.

Example 2.5. The user equipment of any of Example 2.1-2.4, wherein the indication, that the UE is not registered in connection with the sensing services provided by one or more components of the core network, is an indication that the UE is not subscribed to the sensing services.

Example 2.6. The user equipment of any of Example 2.1-1.5, further comprising:
means for receiving, by the UE while in connection management-idle (CM-Idle) state, based on the indication that the UE is registered in connection with the sensing services, a paging message in connection with the sensing service,
wherein the paging message comprises a request for a sensing method.

Example 2.7. The user equipment of Example 2.6, further comprising:
means for determining, by the UE, whether the UE is capable of the sensing method; and
based on the determining, one of the following:
means for accepting the request for the sensing method, or
means for declining the request for the sensing method.

Example 2.8. The user equipment of Example 2.7, further comprising:
means for initiating connection establishment for changing, by the UE, based on the accepting the request for the sensing method, from the CM-Idle state to a connection management-connected (CM-Connected) state.

Example 3.1. An apparatus comprising:
at least one processor; and
at least one memory storing instructions which, when executed by the at least one processor, cause the apparatus at least to perform:
   receiving, by one or more components of a core network, a message comprising information indicating one or more sensing capabilities of a user equipment (UE);
   transmitting, by one or more components of the core network, one of the following:
      an indication that the UE is registered in connection with sensing services provided by one or more components of the core network, or
      an indication that the UE is not registered in connection with the sensing services provided by one or more components of the core network.

Example 3.2. The apparatus of Example 3.1, wherein the message is a registration request configured to register the UE with an access and mobility management function (AMF) of the core network,
wherein the registration request comprises the information indicating the one or more sensing capabilities of the UE.

Example 3.3. The apparatus of Example 3.2, wherein the instructions, when executed by the at least one processor, further cause the apparatus at least to perform:
receiving, by the AMF, from a unified data management function (UDM) of the core network, subscription information of the UE with regard to the sensing services; and
determining, by the AMF, based on the subscription information of the UE with regard to the sensing services, whether to accept or decline the registration request.

Example 3.4. The apparatus of Example 3.3, wherein the instructions, when executed by the at least one processor, further cause the apparatus at least to perform:
transmitting, by the AMF to a management function of the core network supporting the sensing service, based on acceptance of the registration request, a second message comprising the information indicating the one or more sensing capabilities of the UE, the second message configured to update a database storing sensing capabilities of UEs.

Example 3.5. The apparatus of any of Examples 3.1-3.4, wherein the message further comprises information indicating at least one of the following:
the UE capable of operation in a monostatic mode for the sensing service,
the UE capable of operating in a bistatic mode for the sensing services,
the UE capable of a transmission role for the sensing services,
the UE capable of a reception role for the sensing services,
the UE capable of sidelink sensing for the sensing services, or
at least one type of sensing signal that the UE is capable of at least one of: receiving or transmitting.

Example 3.6. The apparatus of any of Example 3.1, wherein the transmitting comprises transmitting the indication that the UE is registered in connection with the sensing services provided by one or more components of the core network,
wherein the UE is in connection management-connected (CM-Connected) state.

Example 3.7. The apparatus of Example 3.6, wherein the instructions, when executed by the at least one processor, further cause the user equipment at least to perform:
receiving a request for the sensing services, the receiving by at least one network function of the following:
a management function, of the core network, that supports the sensing services (SeMF), or
a network exposure function of the core network,
wherein the request for the sensing services indicates a sensing area of interest; and
transmitting, by the network function, to an access and mobility management function (AMF) of the core network, a request for the AMF to discover at least CM-Connected UEs for the request for the sensing services.

Example 3.8. The apparatus of Example 3.7, wherein the instructions, when executed by the at least one processor, further cause the apparatus at least to perform:
obtaining, by the network function, a plurality of defined target areas for the sensing service; and
mapping, by the network function, the sensing area of interest to at least one target area of the plurality of define target areas,
wherein the request for the AMF to discover at least CM-Connected UEs for the request for the sensing services comprises at least one identifier corresponding to the at least one target area mapped to the sensing area of interest.

Example 3.9. The apparatus of Example 3.8, wherein the instructions, when executed by the at least one processor, further cause the apparatus at least to perform:
determining, by the AMF, at least one network node serving the at least one target area; and
transmitting, by the AMF, to the at least one network node, a request for the at least one network node to discover at least CM-Connected UEs for fulfilling the request for the sensing services,
wherein the UE in the CM-Connected state is served by one of the at least one network node.

Example 3.10. The apparatus of Example 3.9, wherein the request for the at least one network node to discover at least CM-Connected UEs for the request for the sensing services comprises at least one of the following:
a requested sensing method,
UE selection criteria, or
number of UEs needed to fulfill the request for the sensing services.

Example 3.11. The apparatus of Example 3.9 or Example 3.10, wherein the instructions, when executed by the at least one processor, further cause the apparatus at least to perform:
receiving, by the AMF, from the at least one network node, discovered information comprising:
   at least one identifier corresponding to at least one CM-Connected UE discovered for the request for the sensing services, and
   for each of the at least one CM-Connected UE, a respective confidence level indicating a level of capability of the respective CM-Connected UE to fulfill the request for the sensing services; and
   transmitting, by the AMF to the SeMF, the discovered information.

Example 3.12. The apparatus of Example 3.11, wherein the instructions, when executed by the at least one processor, further cause the apparatus at least to perform:
selecting, by the SeMF, based on at least the discovered information, at least one of the at least one CM-Connected UE to fulfill the request for the sensing services.

Example 3.13. The apparatus of Example 3.1, wherein the transmitting comprises transmitting the indication that the UE is registered in connection with the sensing services provided by one or more components of the core network,
wherein the UE is in connection management-idle (CM-Idle) state.

Example 3.14. The apparatus of Example 3.13, wherein the instructions, when executed by the at least one processor, further cause the apparatus at least to perform:
receiving a request for the sensing services, the receiving by at least one network function of the following:
   a management function, of the core network, that supports the sensing services (SeMF), or
   a network exposure function of the core network,
   wherein the request for the sensing services indicates a sensing area of interest; and
   transmitting, by the network function, to an access and mobility management function (AMF) of the core network, a request for the AMF to discover at least CM-Idle UEs for the request for the sensing services.

Example 3.15. The apparatus of Example 3.14, wherein the instructions, when executed by the at least one processor, further cause the apparatus at least to perform:
obtaining, by the network function, a plurality of defined target areas for the sensing service;
mapping, by the network function, the sensing area of interest to at least one target area of the plurality of define target areas,
wherein the request for the AMF to discover at least CM-Idle UEs for the request for the sensing services comprises at least one identifier corresponding to the at least one target area mapped to the sensing area of interest.

Example 3.16. The apparatus of Example 3.15, wherein the instructions, when executed by the at least one processor, further cause the apparatus at least to perform:
obtaining, by the AMF, for each CM-Idle UE of a plurality of CM-Idle UEs registered with the AMF:
   at least one respective target area, of the plurality of defined target areas, that is associated with the respective CM-Idle UE;
   determining, by the AMF, at least one CM-Idle UE, of the plurality of CM-Idle UEs registered with the AMF, which has at least one associated target area that overlaps with the at least one target area mapped to the sensing area of interest;
   determining, by the AMF, at least one network node serving the at least one target area mapped to the sensing area of interest; and
   transmitting, by the AMF, to the at least one network node, a request to for the at least one network node to perform paging for the at least one CM-Idle UE for fulfilling the request for the sensing services,
   wherein the UE in the CM-Idle state is served by one of the at least one network node.

Example 3.17. The apparatus of Example 3.16, wherein the request for the at least one network node to perform paging for the at least one CM-Idle UE for fulling the request for the sensing services comprises at least one of the following:
a requested sensing method, or
a setting for the at least one network node to perform paging for any UE having sensing capability.

Example 3.18. The apparatus of Example 3.16 or Example 3.17, wherein the instructions, when executed by the at least one processor, further cause the apparatus at least to perform:
establishing, by the AMF, signaling connection with at least one of the at least one CM-Idle UE, the at least one of the at least one CM-Idle UE changing to connection management-connected (CM-Connected) state and becoming at least one CM-Connected UE.

Example 3.19. The apparatus of Example 3.18, wherein the instructions, when executed by the at least one processor, further cause the apparatus at least to perform: for each of the at least one CM-Connected UE:
receiving, by the AMF, from at least one of the at least one network node, a respective confidence level indicating a level of capability of the respective CM-Connected UE to fulfill the request for the sensing services; and
transmitting, by the AMF to the SeMF, the respective confidence level for the respective CM-Connected UE.

Example 3.20. The apparatus of Example 3.19, wherein the instructions, when executed by the at least one processor, further cause the apparatus at least to perform:
selecting, by the SeMF, based on the at least one confidence level corresponding to the at least one CM-Connected UE, at least one of the at least one CM-Connected UE to fulfill the request for the sensing services.

Example 4.1. An apparatus comprising:
means for receiving, by one or more components of a core network, a message comprising information indicating one or more sensing capabilities of a user equipment (UE);
means for transmitting, by one or more components of the core network, one of the following:
   an indication that the UE is registered in connection with sensing services provided by one or more components of the core network, or
   an indication that the UE is not registered in connection with the sensing services provided by one or more components of the core network.

Example 4.2. The apparatus of Example 4.1, wherein the message is a registration request configured to register the UE with an access and mobility management function (AMF) of the core network,
wherein the registration request comprises the information indicating the one or more sensing capabilities of the UE.

Example 4.3. The apparatus of Example 4.2, further comprising:
means for receiving, by the AMF, from a unified data management function (UDM) of the core network, subscription information of the UE with regard to the sensing services; and
means for determining, by the AMF, based on the subscription information of the UE with regard to the sensing services, whether to accept or decline the registration request.

Example 4.4. The apparatus of Example 4.3, further comprising:
means for transmitting, by the AMF to a management function of the core network supporting the sensing service, based on acceptance of the registration request, a second message comprising the information indicating the one or more sensing capabilities of the UE, the second message configured to update a database storing sensing capabilities of UEs.

Example 4.5. The apparatus of any of Examples 4.1-4.4, wherein the message further comprises information indicating at least one of the following:
the UE capable of operation in a monostatic mode for the sensing service,
the UE capable of operating in a bistatic mode for the sensing services,
the UE capable of a transmission role for the sensing services,
the UE capable of a reception role for the sensing services,
the UE capable of sidelink sensing for the sensing services, or
at least one type of sensing signal that the UE is capable of at least one of: receiving or transmitting.

Example 4.6. The apparatus of Example 4.1, wherein the means for transmitting comprises means for transmitting the indication that the UE is registered in connection with the sensing services provided by one or more components of the core network,
wherein the UE is in connection management-connected (CM-Connected) state.

Example 4.7. The apparatus of Example 4.6, further comprising:
means for receiving a request for the sensing services, the receiving by at least one network function of the following:
   a management function, of the core network, that supports the sensing services (SeMF), or
   a network exposure function of the core network,
   wherein the request for the sensing services indicates a sensing area of interest; and
   means for transmitting, by the network function, to an access and mobility management function (AMF) of the core network, a request for the AMF to discover at least CM-Connected UEs for the request for the sensing services.

Example 4.8. The apparatus of Example 4.7, further comprising:
means for obtaining, by the network function, a plurality of defined target areas for the sensing service; and
means for mapping, by the network function, the sensing area of interest to at least one target area of the plurality of define target areas,
wherein the request for the AMF to discover at least CM-Connected UEs for the request for the sensing services comprises at least one identifier corresponding to the at least one target area mapped to the sensing area of interest.

Example 4.9. The apparatus of Example 4.8, further comprising:
means for determining, by the AMF, at least one network node serving the at least one target area; and
means for transmitting, by the AMF, to the at least one network node, a request for the at least one network node to discover at least CM-Connected UEs for fulfilling the request for the sensing services,
wherein the UE in the CM-Connected state is served by one of the at least one network node.

Example 4.10. The apparatus of Example 4.9, wherein the request for the at least one network node to discover at least CM-Connected UEs for the request for the sensing services comprises at least one of the following:
a requested sensing method,
UE selection criteria, or
number of UEs needed to fulfill the request for the sensing services.

Example 4.11. The apparatus of Example 4.9 or Example 4.10, further comprising:
means for receiving, by the AMF, from the at least one network node, discovered information comprising:
   at least one identifier corresponding to at least one CM-Connected UE discovered for the request for the sensing services, and
   for each of the at least one CM-Connected UE, a respective confidence level indicating a level of capability of the respective CM-Connected UE to fulfill the request for the sensing services; and
   means for transmitting, by the AMF to the SeMF, the discovered information.

Example 4.12. The apparatus of Example 4.11, further comprising:
means for selecting, by the SeMF, based on at least the discovered information, at least one of the at least one CM-Connected UE to fulfill the request for the sensing services.

Example 4.13. The apparatus of Example 4.1, wherein the means for transmitting comprises means for transmitting the indication that the UE is registered in connection with the sensing services provided by one or more components of the core network,
wherein the UE is in connection management-idle (CM-Idle) state.

Example 4.14. The apparatus of Example 4.13, further comprising:
means for receiving a request for the sensing services, the receiving by at least one network function of the following:
   a management function, of the core network, that supports the sensing services (SeMF), or
   a network exposure function of the core network,
   wherein the request for the sensing services indicates a sensing area of interest; and
      means for transmitting, by the network function, to an access and mobility management function (AMF) of the core network, a request for the AMF to discover at least CM-Idle UEs for the request for the sensing services. Example 4.15. The apparatus of Example 4.14, further comprising:
means for obtaining, by the network function, a plurality of defined target areas for the sensing service;
means for mapping, by the network function, the sensing area of interest to at least one target area of the plurality of define target areas,
   wherein the request for the AMF to discover at least CM-Idle UEs for the request for the sensing services comprises at least one identifier corresponding to the at least one target area mapped to the sensing area of interest. Example 4.16. The apparatus of Example 4.15, further comprising:
means for obtaining, by the AMF, for each CM-Idle UE of a plurality of CM-Idle UEs registered with the AMF:
at least one respective target area, of the plurality of defined target areas, that is associated with the respective CM-Idle UE;
means for determining, by the AMF, at least one CM-Idle UE, of the plurality of CM-Idle UEs registered with the AMF, which has at least one associated target area that overlaps with the at least one target area mapped to the sensing area of interest;
means for determining, by the AMF, at least one network node serving the at least one target area mapped to the sensing area of interest; and
means for transmitting, by the AMF, to the at least one network node, a request to for the at least one network node to perform paging for the at least one CM-Idle UE for fulfilling the request for the sensing services,
   wherein the UE in the CM-Idle state is served by one of the at least one network node.

Example 4.17. The apparatus of Example 4.16, wherein the request for the at least one network node to perform paging for the at least one CM-Idle UE for fulling the request for the sensing services comprises at least one of the following:
a requested sensing method, or
a setting for the at least one network node to perform paging for any UE having sensing capability.

Example 4.18. The apparatus of Example 4.16 or Example 4.17, further comprising:
means for establishing, by the AMF, signaling connection with at least one of the at least one CM-Idle UE, the at least one of the at least one CM-Idle UE changing to connection management-connected (CM-Connected) state and becoming at least one CM-Connected UE.

Example 4.19. The apparatus of Example 4.18, further comprising, for each of the at least one CM-Connected UE:
means for receiving, by the AMF, from at least one of the at least one network node, a respective confidence level indicating a level of capability of the respective CM-Connected UE to fulfill the request for the sensing services; and
means for transmitting, by the AMF to the SeMF, the respective confidence level for the respective CM-Connected UE.

Example 4.20. The apparatus of Example 4.19, further comprising:
means for selecting, by the SeMF, based on the at least one confidence level corresponding to the at least one CM-Connected UE, at least one of the at least one CM-Connected UE to fulfill the request for the sensing services.

Example 5.1. A method comprising:
receiving, by one or more components of a radio access network (RAN), a message comprising information indicating one or more sensing capabilities of a user equipment (UE);
transmitting, by one or more components of the RAN, one of the following:
   an indication that the UE is registered in connection with sensing services provided by one or more components of a core network, or
   an indication that the UE is not registered in connection with the sensing services provided by one or more components of the core network.

Example 5.2. The method of Example 5.1, wherein the message is a registration request configured to register the UE with an access and mobility management function (AMF) of the core network,
wherein the registration request comprises the information indicating the one or more sensing capabilities of the UE.

Example 5.3. The method of Example 5.1 or Example 5.2, further comprising:
receiving, by at least one network node of the RAN, from an access and mobility management function (AMF) of the core network, at least one identifier for at least one target area which covers a sensing area of interest, the sensing area of interest specified in a request for the sensing services, wherein the at least one network node services the at least one target area; and
receiving, by the at least one network node of the RAN, from the AMF, a request to discover at least connection management-connected (CM-Connected) UEs in the at least one target area.

Example 5.4. The method of Example 5.3, wherein the request to discover at least CM-Connected UEs in the at least one target area comprises at least one of the following:

a requested sensing method,

UE selection criteria, or
number of UEs needed to fulfill the request for the sensing services.

Example 5.5. The method of Example 5.3 or Example 5.4, further comprising:
obtaining, by the at least one network node of the RAN, discovered information comprising:
at least one identifier corresponding to at least one CM-Connected UE discovered for the request for the sensing services, and
for each of the at least one CM-Connected UE, a respective confidence level indicating a level of capability of the respective CM-Connected UE to fulfill the request for the sensing services; and
transmitting, by the at least one network node of the RAN, to the AMF, the discovered information.

Example 5.6. The method of Example 5.1 or Example 5.2, further comprising:
receiving, by at least one network node of the RAN, from an access and mobility management function (AMF) of the core network, at least one identifier for at least one target area which covers a sensing area of interest, the sensing area of interest specified in a request for the sensing services, wherein the at least one network node services the at least one target area; and
receiving, by the at least one network node of the RAN, from the AMF, a request to perform paging for at least one connection management-idle (CM-Idle) UE for fulfilling the request for the sensing service.

Example 5.7. The method of Example 5.6, wherein the request to perform paging for the at least one CM-Idle UE for fulling the request for the sensing services comprises at least one of the following:
a requested sensing method, or
a setting for the at least one network node to perform paging for any UE having sensing capability.

Example 5.8. The method of Example 5.6 or Example 5.7, further comprising:
transmitting, by the at least one network node of the RAN, to the at least one CM-Idle UE, a paging message configured to cause at least one of the at least one CM-Idle UE to initiate connection establishment to change to a connection management-connected (CM-Connected) state, the at least one of the at least one CM-Idle UE becoming at least one CM-Connected UE.

Example 5.9. The method of Example 5.8, further comprising, for each of the at least one CM-Connected UE:
determining, by a network node of the RAN, a respective confidence level indicating a level of capability of the respective CM-Connected UE to fulfill the request for the sensing services; and
transmitting, by the at least one network node of the RAN, to the AMF, the respective confidence level for the respective CM-Connected UE.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A user equipment (UE) comprising:
at least one processor; and
at least one memory storing instructions which, when executed by the at least one processor, cause the user equipment at least to perform:
transmitting, to one or more components of a core network, a message comprising information indicating one or more sensing capabilities of the UE; and
receiving one of the following:
an indication that the UE is registered in connection with sensing services provided by the one or more components of the core network, or
an indication that the UE is not registered in connection with the sensing services provided by the one or more components of the core network.

2. The UE as claimed in claim 1, wherein the message is a registration request configured to register the UE with an access and mobility management function (AMF) of the core network, the one or more components of the core network comprising the AMF,
wherein the registration request comprises the information indicating the one or more sensing capabilities of the UE.

3. The UE as claimed in claim 1, wherein the message further comprises information indicating at least one of the following:
the UE is capable of operation in a monostatic mode for the sensing service,
the UE is capable of operating in a bistatic mode for the sensing services,
the UE is capable of a transmission role for the sensing services,
the UE is capable of a reception role for the sensing services,
the UE is capable of sidelink sensing for the sensing services, or
at least one type of sensing signal that the UE is capable of at least one of: receiving or transmitting.

4. The UE as claimed in claim 1, wherein at least one of:
the indication that the UE is registered in connection with the sensing services provided by the one or more components of the core network comprises an indication that the UE is subscribed to the sensing services; or
the indication that the UE is not registered in connection with the sensing services provided by the one or more components of the core network comprises an indication that the UE is not subscribed to the sensing services.

5. The UE as claimed in claim 1, further comprising:
receiving, by the UE while in connection management-idle (CM-Idle) state, based on the indication that the UE is registered in connection with the sensing services, a paging message in connection with the sensing service,
wherein the paging message comprises a request for a sensing method.

6. The UE as claimed in claim 5, further comprising:
determining, by the UE, whether the UE is capable of the sensing method; and
based on the determining, one of the following:
accepting the request for the sensing method, or
declining the request for the sensing method.

7. The UE as claimed in claim 6, further comprising:
initiating connection establishment for changing, by the UE, based on the accepting the request for the sensing method, from the CM-Idle state to a connection management-connected (CM-Connected) state.

8. A method of a user equipment, the method comprising:
transmitting, to one or more components of a core network, a message comprising information indicating one or more sensing capabilities of the UE; and
receiving one of the following:
an indication that the UE is registered in connection with sensing services provided by the one or more components of the core network, or
an indication that the UE is not registered in connection with the sensing services provided by the one or more components of the core network.

9. A method comprising:
receiving, by one or more components of a core network, a message comprising information indicating one or more sensing capabilities of a user equipment (UE);
transmitting, by the one or more components of the core network, one of the following:
an indication that the UE is registered in connection with sensing services provided by the one or more components of the core network, or
an indication that the UE is not registered in connection with the sensing services provided by the one or more components of the core network.

10. The method as claimed in claim 9, wherein the message is a registration request configured to register the UE with an access and mobility management function (AMF) of the core network, the one or more components of the core network comprising the AMF,
wherein the registration request comprises the information indicating the one or more sensing capabilities of the UE; and
wherein the transmitting the one transmits the indication that the UE is registered in connection with sensing services provided by the one or more components of the core network.

11. The method as claimed in claim 10, further comprising:
receiving, by the AMF, from a unified data management function (UDM) of the core network, subscription information of the UE with regard to the sensing services; and
determining, by the AMF, based on the subscription information of the UE with regard to the sensing services, whether to accept or decline the registration request.

12. The method as claimed in claim 11, further comprising:
transmitting, by the AMF to a management function of the core network supporting the sensing service, based on acceptance of the registration request, a second message comprising the information indicating the one or more sensing capabilities of the UE, the second message configured to update a database storing information indicating sensing capabilities of UEs.

13. The method as claimed in claim 9, wherein the message further comprises information indicating at least one of the following:
the UE is capable of operation in a monostatic mode for the sensing service,
the UE is capable of operating in a bistatic mode for the sensing services,
the UE is capable of a transmission role for the sensing services,
the UE is capable of a reception role for the sensing services,
the UE is capable of sidelink sensing for the sensing services, or
at least one type of sensing signal that the UE is capable of at least one of: receiving or transmitting.

14. The method as claimed in claim 9, wherein the transmitting the one comprises transmitting, to the UE, the indication that the UE is registered in connection with the sensing services provided by the one or more components of the core network,
wherein the UE is in connection management-connected (CM-Connected) state.

15. The method as claimed in claim 14, further comprising:
receiving a request for the sensing services, the receiving by at least one network function of the following:
a management function, of the core network, that supports the sensing services (SeMF), or
a network exposure function of the core network,
wherein the request for the sensing services indicates a sensing area of interest; and
transmitting, by the at least one network function, to an access and mobility management function (AMF) of the core network, a request for the AMF to discover at least CM-Connected UEs for the request for the sensing services, the one or more components of the core network comprising the AMF.

16. The method as claimed in claim 15, further comprising:
obtaining, by the at least one network function, a plurality of defined target areas for the sensing service; and
mapping, by the at least one network function, the sensing area of interest to at least one target area of the plurality of defined target areas,
wherein the request for the AMF to discover at least CM-Connected UEs for the request for the sensing services comprises at least one identifier corresponding to the at least one target area mapped to the sensing area of interest.

17. The method as claimed in claim 16, further comprising:
determining, by the AMF, at least one network node serving the at least one target area; and
transmitting, by the AMF, to the at least one network node, a request for the at least one network node to discover at least CM-Connected UEs for fulfilling the request for the sensing services,
wherein the UE in the CM-Connected state is served by one of the at least one network node.

18. The method as claimed in claim 17, wherein the request for the at least one network node to discover at least CM-Connected UEs for the request for the sensing services comprises information identifying at least one of the following:
a requested sensing method,
UE selection criteria, or
number of UEs needed to fulfill the request for the sensing services.

19. The method as claimed in claim 17, wherein the at least one network function comprises the SeMF, the method further comprising:
receiving, by the AMF, from the at least one network node, discovered information comprising:
at least one identifier corresponding to at least one CM-Connected UE discovered for the request for the sensing services, and
for each of the at least one CM-Connected UE, a respective confidence level indicating a level of capability of the respective CM-Connected UE to fulfill the request for the sensing services; and
transmitting, by the AMF to the SeMF, the discovered information.

20. The method as claimed in claim 19, further comprising:
selecting, by the SeMF, based on at least the discovered information, at least one of the at least one CM-Connected UE to fulfill the request for the sensing services.

21. The method as claimed in claim 16, further comprising:
obtaining, by the AMF, for each CM-Idle UE of a plurality of CM-Idle UEs registered with the AMF:
at least one respective target area, of the plurality of defined target areas, that is associated with the respective CM-Idle UE;
determining, by the AMF, at least one CM-Idle UE, of the plurality of CM-Idle UEs registered with the AMF, which has at least one associated target area that overlaps with the at least one target area mapped to the sensing area of interest;
determining, by the AMF, at least one network node serving the at least one target area mapped to the sensing area of interest; and
transmitting, by the AMF, to the at least one network node, a request to for the at least one network node to perform paging for the at least one CM-Idle UE for fulfilling the request for the sensing services,
wherein respective CM-Idle UE of the plurality of CN-Idle UE is served by a corresponding one of the at least one network node.
